(19) United States
(12) Patent Application Publication
(10) Pub. No.: US 2017/0131947 A1
(43) Pub. Date: May 11, 2017

(54) Data and collection methods to analyze life acceleration of SSD with real usages

(71) Applicants: Pho Hoang, Rancho Santa Margarita, CA (US); Phu Pham, Rancho Santa Margarita, CA (US)

(72) Inventors: Pho Hoang, Rancho Santa Margarita, CA (US); Phu Pham, Rancho Santa Margarita, CA (US)

(21) Appl. No.: 15/011,457

(22) Filed: Jan. 29, 2016

Related U.S. Application Data
(60) Provisional application No. 62/252,418, filed on Nov. 6, 2015.

(51) Int. Cl. G06F 3/06; G06F 12/02

(52) U.S. Cl. CPC G06F 3/0653; G06F 3/0604; G06F 3/0679; G06F 12/0246; G06F 2212/7211

(57) ABSTRACT

Data, such as indicators of storage devices, are logged periodically with the recorded time. The time logged data, e.g., data collected at different times, can be used to calculate properties and characteristics of the storage devices, including instantaneous properties and time evolution properties.

### BACKGROUND

The present invention generally relates to improvements in storage devices, and in particular to storage devices using flash memories as a storage medium.

Random access nonvolatile storage media such as magnetic disks have been used as the data storage media. For example, re-writable high capacity storage devices include hard disk drives.

In recent years, various erasable nonvolatile semiconductor memory devices have been developed, called solid state drives, which include flash memory devices. Solid state drives can be low cost, low power consumption, and fast access time.

However, flash memories have a reduced number of erase and write operations. Flash memories also must be erased before it can be rewritten. In addition, a block of memory, e.g., a large number of memory cells such as 512 KB including 128 pages at 4 KB per page, must be erased at the same time. This can shorten the life time of the solid state drive due to the limited number of program/erase cycles (p/e cycles) and impact the performance of the solid state drive due to the moving of data for memory block erase. There is a need for an improved life time and performance for solid state drives.

### SUMMARY OF THE EMBODIMENTS

In some embodiments, the present invention discloses methods and systems for storage devices, such as flash memory devices or solid state drives, to have time related characteristics. Indicators, such as performance and life acceleration data, of the storage devices can be recorded as a function of time, which can allow the calculation of life expectancy in term of time, and which can allow the evaluation of the impact of different workloads or firmware.

In some embodiments, the present invention discloses methods and systems for periodically logging data, such as attributes of storage devices, optional with the recorded time. For example, the attributes can be logged at regular time or index intervals. The time-related recorded information can allow the characteristic calculation of the storage devices having time units, such as a remaining life time of the storage devices in days or years.

In some embodiments, the present invention discloses methods and systems for simplifying the process of logging the workloads for correlating and calculating life expectancy of the storage devices. The attributes of the storage devices can be stored as accumulated data by a monitoring process, such as a Self-Monitoring, Analysis and Reporting Technology (SMART) system. The accumulated attribute data can be periodically logged, e.g., time stamped and indexed, for example, by the host of the storage device. Performance and life acceleration data of the storage device can be calculated from the time logged data.

In some embodiments, the present invention discloses methods and systems for using the logged data set, e.g., data collected at different times, to calculate properties and characteristics of the storage devices. For example, since the logged data set is time-related, time-related properties can be determined, such as a remaining lifetime of the storage devices in term of time, such as days or years.

In some embodiments, the logged data set can be used to calculate correlation between different indicators, e.g., characteristics, of the storage devices. For example, erase counts, e.g., program/erase cycles, or error rates, such as read error rate or write error rate, can be calculated as a function of the inside temperature of the storage devices. Further, the correlation can be used to adjust the data for property calculation. For example, erase counts can be adjusted to be at a same temperature, so that a remaining lifetime of the storage devices can be determined for a same temperature. Also, worse case, best case, and average remaining lifetime of the storage devices can be calculated, for example, based on a maximum, a minimum, or an average temperature of the storage devices.

In some embodiments, the logged data set can be used to calculate instantaneous properties or characteristics of the storage devices. The instantaneous values can be viewed as the properties or characteristics of the storage devices at a particular point in time (or index), in contrast to typical logged data of accumulated values, which are accumulated from the beginning of the storage devices until the present. The instantaneous values can be used to characterize a load on the storage devices, e.g., a memory written to or read from the storage devices, to characterize a firmware of the storage devices, e.g., a program run by the storage devices, for example, to manage the storage devices such as performing wear leveling or garbage collection, or to characterize a software of a host system that is coupled to the storage devices for accessing the storage devices, such as writing to or reading from the storage devices.

In some embodiments, the logged data set can be used to calculate time evolution properties or characteristics of the storage devices. The time evolution values can be viewed as a collection of instantaneous values, e.g., showing the properties or characteristics of the storage devices as a function of time or index (e.g., the memory amounts written to the storage devices). The properties or characteristics of the storage devices can be calculated from the time evolution values, for example, by averaging or by integration.

### BRIEF DESCRIPTION OF THE DRAWINGS

FIG. 1 illustrates a solid state drive and its operation according some embodiments.

FIGS. 2A-2B illustrate solid state drives having logging modules according to some embodiments.

FIGS. 3A-3B illustrate operations of a solid state drive according to some embodiments.

FIGS. 4A-4C illustrate flow charts for forming time or index logged data according to some embodiments.

FIGS. 5A-5C illustrates flow charts for generating an index or time logging process according to some embodiments.

FIGS. 6A-6D illustrate flow charts for using the logged data according to some embodiments.

FIGS. 7A-7C illustrate flow charts for calculating a remaining lifetime of a solid state drive according to some embodiments.

FIGS. 8A-8B illustrate flow charts for forming relationships between various characteristics, attributes or parameters of a solid state drive according to some embodiments.

FIGS. 9A-9B illustrate flow charts for calculating properties at same conditions according to some embodiments.

FIGS. 10A-10C illustrate flow charts for calculating instantaneous properties according to some embodiments.

FIGS. 11A-11B illustrate flow charts for calculating effect of software, firmware or load on a solid state drive according to some embodiments.

FIGS. 12A-12C illustrate flow charts for using a property calculation in a regression test according to some embodiments.

FIG. 13A-13C illustrate time or index evolution property calculations according to some embodiments.

FIGS. 14A-14B illustrate flow charts for calculating adjusted time evolution properties according to some embodiments.

FIG. 15 illustrates a computing environment according to some embodiments.

FIG. 16 is a schematic block diagram of a sample computing environment with which the present invention can interact.

### DETAILED DESCRIPTION OF THE EMBODIMENTS

In some embodiments, the present invention discloses methods, systems, and devices having the methods implemented, for periodically storing workload-related behaviors and characteristics of storage devices, such as flash memory devices which are commonly called solid state drives (SSD) or solid state disks. A logging module can be added to record the characteristics of the solid state drives as a function of time, e.g., the recording can include a time stamped and/or size indexed. The time characteristics of the storage devices can then be analyzed, when needed, to provide indication and improvement of the life time or performance of the solid state drives.

The analyzed time characteristics of the storage devices can be used to provide an indication of time on the life expectancy of the storage devices. Currently, SSD life expectancy tools normally give users a percentage of life remaining or a remaining number of terabytes which can be securely written. For example, an SSD attribute, e.g., an SSD indicator, can show that there is 80% of life remaining, but the information does not tell when the storage drives will need to be replaced. Is it tomorrow, next month, or 10 years from now?

In some embodiments, the present invention can perform an analysis of the behavior of the storage devices as a function of time, thus the remaining time of the storage devices can be estimated, which can give the users the life usage estimation in date and times. Thus, the users can know when the drive life will be ended based on the current usage.

The time characteristics of the storage devices can be used to provide an assessment of the effect of different workloads or software programs. For example, time characteristics can show a user how the daily workload affecting the life expectancy and/or performance. For example, when a user subjects the storage drive to a new workload, a new software or firmware, the time characteristics of the storage drive will correspondingly show a change in performance and/or life expectancy. The change will allow the user to understand the impact of the storage drive in new situations, such as a new workload, a new firmware, or a new software.

For example, when a user installs new software or changes a software in their system, the usage or workload on a SSD can be changed, which can also change the life expectancy and performance of the storage drive. The present time characteristic logging can show the user whether the change has positive or negative impact on the storage drive in a short period, such as in a few days. The present method can provide a big advantage for users evaluating new software, fixing software, or doing system regression tests.

Further, the time characteristic logging can allow a user to trace a sudden change in performance or life time of the storage drive. For example, when the user experiences a sudden drop in performance, the time characteristic logging can show the time when the change starts, and the user can identify the events that cause the damages.

In some embodiments, the present method can use real data, e.g., when the user is using the storage drive in the system, to calculate the time characteristics of the storage drive. For example, the method can provide a way to calculate life expectancy of the storage drive based on real usage. Thus the method can offer a more accurate life expectancy and performance to the user, for example, as compared to modeling of workload data when calculating life expectancy.

In some embodiments, the present invention discloses a simplified method to obtain the characteristics of a storage drive, such as the behavior of the storage drive under different workloads or software. The method can simplify how a user can collect workload data and calculate life expectancy as a function of time. The method can distribute the life acceleration data collection between the host and the storage drive, thus helping the storage drive keeping its performance.

For example, the storage drive can provide performance and life acceleration data in SMART log, including data writes, data reads, NAND consumption parameters (e.g., NAND erase count or program/erase cycle count), and life remaining percentage. The host can, while the storage drive is in use, read the SMART attributes, e.g., indicators generated by the SMART program or system, and log the data periodically. The host can also add index and time stamp for each data log, thus creating a time characteristic log of the storage drive.

In some embodiments, the present invention discloses methods to assist a user in building a software for knowing life expectancy in a timing sense, e.g., the drive will die in 3 months with this workload, and 2 years with another workload. The user can know the history, the trend of workloads, and how the workloads can affect the life expectancy of the storage drive.

Solid state drives can have a life expectancy, mainly due to the maximum number of program and erase (program/erase or p/e) cycles that a flash memory can endure. A program/erase cycle can include a process of programming (e.g., writing to a flash memory) and then erasing the flash memory. Similarly, the program/erase cycle can include a process of erasing and then programming a flash memory.

Before writing to a flash memory, the memory will need to be first erased, using one p/e cycle for the memory. Thus the number of program/erase cycles can also be called erase counts, e.g., the number of erases performed on the memory.

The determination of life expectancy can be further complicated since writing can be performed on a page of memory, instead of just one byte. In addition, erasing operation can only be performed on a block, which can be 16-128 pages.

Thus, in a worst case scenario, rewriting one byte can force rewriting a page, which can be 1-4 Kbytes. Since the memory will need to be erased before rewriting, rewriting one byte can force erasing one block, thus consuming up to 512,000 p/e cycles, since a block of 512 Kbytes of memory can be erased to prepare for writing the one byte of data. Clever mapping algorithms had been developed to alleviate this issue. However, a certain amount of write amplification is always unavoidable.

In some embodiments, the present invention discloses a time-based workload logging feature for monitoring the workload of a solid state drive, which can be used to predict the life expectancy of the solid state drive, for example, through the consumption of p/e cycles. The workload logging feature can provide an indication of how long the drive will last, e.g., how fast the drive life will go down based on the current workload. Further, the workload logging feature can also provide changes in the predicted life expectancy when the workload is changed.

The correlation and calculation of the life expectancy of a solid state drive are based on actual usage, e.g., the logged workloads, of the solid state drive while the solid state drive is being used. This is in contrast to model data, or data that is generic to all workloads, and thus not really suitable for the particular workload that the current solid state drive is experiencing. Hence, it will give the most accurate life expectancy data to the user. The method can also provide the user with the history, trend, sense of timing on life expectancy, and sense of workloads in their system.

In some embodiments, the present invention discloses storage devices with time-based workload logging features, and methods and systems to implement the storage devices. The storage devices can include solid state devices which have flash memory packages connected to a controller.

Solid state devices utilize solid state memory arrays, thus there are no mechanical moving parts, leading to potential higher reliability. In addition, the memory arrays can be configured to allow parallel processing, leading to potential faster access time.

The solid state memory arrays can include flash memory devices, which differ from other forms of memory storage since the flash memory devices cannot be overwritten without first being erased. Furthermore, the flash memory devices have limited re-writing cycles, thus wear leveling is typically implemented, in which the usage of the flash memory devices are uniformly spread around the solid state drives.

For example, block-level wear leveling can be used by a controller of the flash memory devices to track the erase and write status of various memory blocks. New blocks can be allocated for use to accommodate newly received data, evenly distributing the usage of memory blocks.

To hide the differences of the solid state drives, e.g., the high erase overhead, a memory access abstraction can be implemented, for example, in the flash translation layer. A logical-to-physical address mapping can represent the physical addresses of the flash memory devices with logical addresses, e.g., logical addresses of traditional hard drives, to the application software.

Operations of a flash memory are explained below. A block in a flash memory is a memory unit for collectively erasing data. A page is a memory unit for reading and writing data. A block can have multiple pages. A word is a memory unit for data modification. A page can have multiple words. The flash memory cannot directly rewrite data. The memory will need to be erased before new data can be rewritten at that memory. Thus, in a typical operation, when a new data needs to be rewritten to a word in a block of the flash memory, the stored valid old data in the block is saved, e.g., written, to another block. The old data in the block are erased, and then the new data is written to the erased block. Some algorithms handle this using different techniques of read-modify-writing. For example, the old data can be read into volatile memory buffer. The modified words are updated in memory and then are written to a different NAND location. The mapping structure is then changed to reference the logical address to the new physical address.

Thus the rewriting of data in a flash memory necessitates more writing or erasure compared to the amount needed or intended, which can severely affect the rewriting performance of the flash memory. Thus it can be necessary to write data to a flash memory using an algorithm capable of hiding the time required to erase data from the flash memory. A flash memory also can have limited erasure times, thus a block with excessively high erase count can become unusable since data can no longer be erased from such block. Thus it can be necessary to even the erase counts of the memory blocks.

Flash memory is accessed via a driver, which accepts reads and writes in units of sectors, corresponded to hard drive devices. If the driver writes data directly to the physical sector address, this could require an entire block to be erased during every write process, leading to slow access time and unevenly flash memory wear. Thus, repeated writes of a same data should be written to different physical locations of the flash memory. In other words, the address of a same data would be changed every time the data is rewritten. To present a consistent, e.g., unchanged, data address even though the data is written, logical addresses for the data are introduced, together with a mapping that translates the logical addresses to physical addresses. To the host system, the address of the data is the logical address, which is unchanged no matter how many times it is rewritten. The mapping can handle the address change, e.g., mapping the logical address of the data to different physical addresses in the flash memory every time the data is rewritten.

Thus an address mapping process and table, which translates logical addresses to physical addresses, is performed in the flash memory module upon writing data. A controller can be used to provide a logical address to an external host or processor, and also provide a physical address with respect to the solid state drive. The controller can manage the solid state drive using the physical addresses, and can convert the physical addresses into the logical addresses. A layer, e.g., an abstract concept of solid state drive partitions, in which logical addresses and physical addresses are converted from each other are typically referred to as a flash translation layer (FTL).

A solid state drive can be coupled to a host system, which interfaces with the solid state drive as though it were a hard disk drive. The solid state drive can contain a mapping table for mapping to addresses, e.g., converting between logical and physical addresses. The mapping table can be stored in the solid state drive on random access memory (RAM). The mapping table can be generated upon initialization, such as when it is connected to the host system. The mapping table can be lost when power is removed, such as when it is removed from the host system. Thus upon initialization, the solid state drive can be scanned to generate the mapping table. Some algorithms implement ways to preserve the mapping table to some extent across power lost in order to optimize the mapping table reconstruction process.

The FTL can use an address mapping table to perform a rapid address mapping operation, for example, RAM or static random access memory (SRAM). Using the address mapping function of the FTL, a host system can recognize the solid state drive as a hard drive, and can access the solid state drive in the same manner as the hard disk. The FTL can be included in the solid state drive and independent to the host system.

The address mapping methods can include a page-level address mapping method, a block-level address mapping method, and a hybrid address mapping method. In the page-level address mapping method, the unit of the mapping table is commonly page unit size, meaning a logical page of data is converted into a physical page. In the case of a block-level address mapping method, the unit of the mapping table is commonly block unit size, meaning a logical block of data is converted into a physical block.

Page-level address mapping can provide good performance due to address conversion with greater accuracy, but it can be expensive due to the large size requirement of the address mapping table. Block-level address mapping requires smaller size, but it can be expensive to manage because it must erase and update a whole data block even when a single page in the block is changed.

In the case of a hybrid mapping method, the mapping table can be either page unit or block unit size, such as using a page-level address mapping method over a log block and a block-level address mapping method over a data block. In some cases, fine grained page mapping can be reserved for data that is changed frequently, while block mapping can be reserved for data that are changed less frequently.

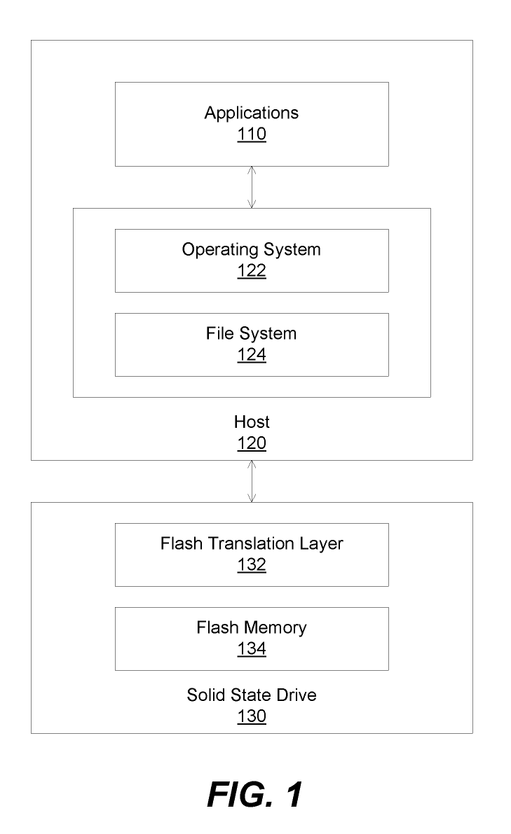

FIG. 1 illustrates a solid state drive and its operation according some embodiments. A solid state drive 130 is coupled to a host system 120, such as a computer or a data processing system. The solid state drive 130 can include a flash memory 134. The flash memory 134 can include a set of flash memory packages, with each memory package having one or more dies. Each die can have multiple planes, which have many blocks, with each block having multiple pages.

The flash memory 134 can be connected to a controller for managing the memory. For example, the controller can include a host interface logic for communicating with the host 120, logic, memory buffer, and flash demux/mux to access the flash memory 134, optional memory such as RAM (read-write memory) for potential application software, and a flash translation layer 132.

The controller can utilize firmware, e.g., application software for the solid state drive 130, for many functions instead of hardware, for example, to reduce the cost of the solid state drives. For example, the firmware can include a flash translation layer mapping, which can map the physical addresses of the memory 134 to logical addresses that the host 120 requires. The flash translation layer mapping, e.g., a software loaded to the flash translation layer 132, can hide the characteristics of the flash memory 134, and can present the flash memory 134 under a file system 124 to the host 120, such as file systems utilized by hard drives.

The host 120 can include an operating system 122, such as Windows operating system or MAC operating system. The operating system 122 can be configured to recognize various file systems 124, such as FAT, NTFS, file systems used by Linux, or file systems used by MAC OS. The flash translation layer mapping, resided in the flash translation layer 132, can translate the characteristics of the file system 124 to the characteristics of the flash memory 134, allowing the host system 120, e.g., the applications 110 run by the host 120, to access the solid state drives without any knowledge of the internal structures and behaviors of the solid state drives. Thus despite the complexity and differences of the solid state drives, through the flash translation layer, the host system can view the solid state drive as a hard drive, with the characteristics indicated by the file system 124.

The above description is overly simplified in order to illustrate the function of the flash translation layer or the logical-to-physical address mapping table. In practice, the flash memory at physical address might need to be erased by erasing a whole block containing the physical sector. Garbage data collection and wear leveling mechanisms also need to be implemented.

For example, a complete sequence of an out-of-place write can include choosing a free flash memory page, then writing the new data to it, followed by invalidating the previous version of the page involved, and then updating the logical-to-physical address map to reflect the address change. Thus the controller of the solid state drive can maintain a data structure for the pool of free flash memory blocks in which data can be written. The data pages of the free flash memory blocks can be allocated to the write requests can be dictated by a data placement function responsible for wear leveling, for example. The out-of-place write operation thus requires a garbage collection routine to reclaim invalid pages dispersed in flash memory blocks, copying valid pages out of the memory block, then erasing the block and adding the erased block to the pool of free blocks.

In some embodiments, the present invention discloses methods and systems for assisting in operating a solid state drive, including providing time-related information of the solid state drive, thus providing performance and life data based on events to the solid state drive. The event characteristics can allow possible improvements, for example, by evaluating the software updates applied to the solid state drive. Actual workloads of the solid state drive can be used to provide information related to the characteristics of the solid state drive, such as life time expectancy and performance of the drive. In addition, the event related characteristics of the solid state drive can be used in routines called by the user, which can indicate the effectiveness of the updated software. For example, a new software can be evaluated by comparing the new performance and lifetime of the solid state drive with those of the old software.

In some embodiments, the present invention discloses a workload log for a solid state drive. The workload log can be stored in the solid state drive or in the connected host. The workload log can include the attributes of the solid state drive, such as the attributes or indicators in SMART (Self-Monitoring, Analysis and Reporting Technology) log. The workload log can also include summary and/or details of the operation commands. For example, the workload log can include at least one of operation commands, read operations, sizes of read operations, write operations, sizes of write operations, erase operations, garbage collection operation, sizes of garbage collection operations, wear leveling operations, sizes of wear leveling operations, buffer operations, sizes of buffer operations, over provisioning operations, sizes of over provisioning operations, and sequential or random characteristics of read and write operations.

In some embodiments, the attributes or indicators of the solid state drive, such as the read operations, write operations, sizes and frequencies of the operations, and the internal operations, such as the wear leveling process and the garbage collection process, life expectancy and performance, can be recorded. The recorded data can be analyzed in view of the workloads or the software to identify workloads or software with better or worse drive characteristics. The recorded data can also be analyzed to identify algorithms, e.g., garbage collection or wear leveling algorithm, that can improve the drive life time or performance. Information related to the characteristics of the solid state drive, such as projected life time and performance, can be provided, for example, in a visual presentation, to allow a user to understand the solid state drive operations. Improvements to the solid state drive can be suggested and implemented.

In some embodiments, the present invention discloses a logging software for logging operations in a solid state drive. A logging module can include a memory portion for storing the logged data. A logging software, e.g., a program, can be used to log, e.g., record, the operations of the solid state drive. The logging software can be loaded to a controller, such as an operating controller of the solid state drive or a special controller for logging operations. The logging software can be stored in the logging module or can be stored in a memory portion in the solid state drive. The logging software can be a standalone software, running independent of the operating software of the solid state drive. The logging software can be an integrated part of the operating software of the solid state drive, e.g., including subroutines or modules that can be called from the operating software.

The logging software can be configured to record summary and/or details of the operations of the solid state drive, including external operations and internal operations. The logging software can record operation details to the memory module, to the memory block level, to the memory page level, or to the memory cell level. For example, the logging software can record the erase number of each memory block, forming a table of erase counts v. the memory blocks of the solid state drive. The logging software can record the read or write operations on each page or each block. The logging software can also record the number of times the controller used to write a data, e.g., the write amplification characteristic of each write data.

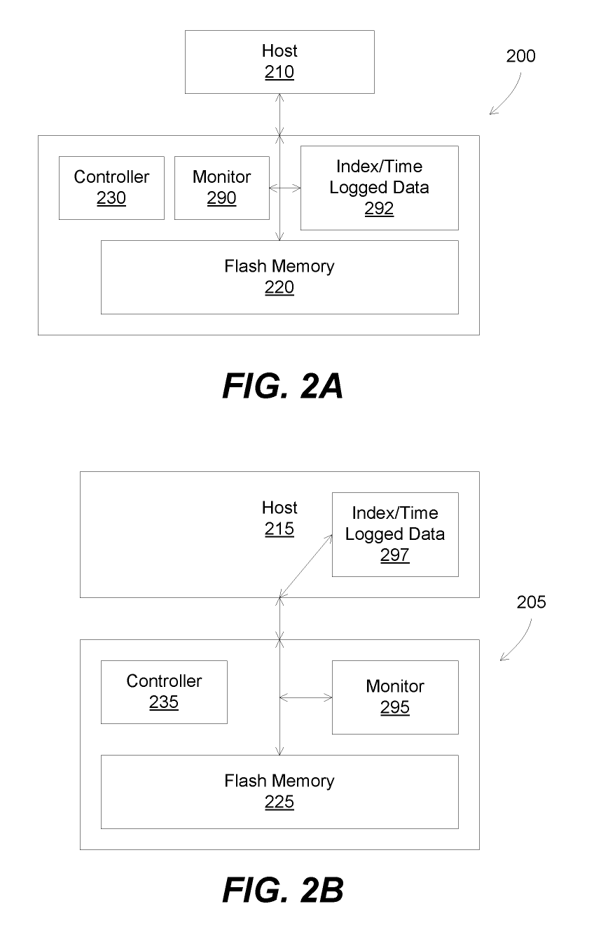

FIGS. 2A-2B illustrate solid state drives having logging modules according to some embodiments. The logging module can include a logging software for performing the data logging, and a memory portion for storing the logged data. The logged data can be stored in the solid state drive or in the host.

In FIG. 2A, a solid state drive 200 can be connected to a host 210. The solid state drive 200 can include flash memory portion 220, together with a controller 230 for operating the solid state drive 200. A monitor program 290, such as a SMART monitoring system, can detect and report the attributes or indicators of the solid state drive 200, for example, for monitoring the drive reliability.

A logging program can be used to periodically record the monitored attributes, e.g., the indicator of the SMART program. The time logged data 292 can be stored in the solid state drive. The time logged data can include the SMART attributes, such as Raw Read Error Rate, Retired Block Count, Power-On Hours, Device Power Cycle Count, Soft Read Error Rate, Gigabytes Erased, Reserve Block Count, Program Fail Count, Erase Fail Count, Unexpected Power Loss, Wear Range Delta, Program Fail Count, Erase Fail Count, Reported I/O Error Detection Code Errors (IOEDC errors), Reported Uncorrectable Errors (URAISE), Temperature, ECC On-the-Fly Error Count, Reallocation Event Count, Uncorrectable Sector Count, SATA R-Errors Error Count, Uncorrectable Soft Read Error Rate (UECC), Soft ECC Correction Rate (UECC), Drive Life Protection Status, SSD Life Left, Available Reserved Space, Power Fail Backup Health, Lifetime Writes from Host System, Lifetime Reads to Host System. The essential parameters can include data writes, data reads, NAND consumption parameters (NAND erase count), and life remaining percentage. Other parameters can provide an indication of performance, such as the temperature of the SSD.

In addition, the logged data can include attributes or indicators of the solid state drive, and details of the internal operations of the solid state drive, such as erase operations, garbage collection operations, wear leveling operations, and other information related to the operations of the solid state drive, such as using the look ahead information, using the buffer information, using the over provisioning memory, moving static data stored in the solid state drive. The logged data can include characteristics of the internal operations, such as the aligned or non-aligned characteristics of the block memory in writing operations, the random characteristics of the read or write data, and the sequential characteristics of the read or write data. In some embodiments, the performance of the solid state drive can also be logged, such as the read and write access times, e.g., the time it takes for returning the read data after receiving a read command, or the time it takes to perform the write operation from the write command. Raw or processed data can be recorded. Alternatively, semi-processed data can be recorded for reducing storage space, such as data can be accumulated and then stored by memory blocks or memory pages, such as block erase/block write, or block erase/page write.

In FIG. 2B, a solid state drive 205 can be connected to a host 215. The solid state drive 205 can include flash memory portion 225, together with a controller 235 for operating the solid state drive 205. A monitor program 295, such as a SMART monitoring system, can detect and report the attributes or indicators of the solid state drive 205, for example, for monitoring the drive reliability.

The attributes generated by the SMART monitoring system 295 can be sent to the host to be stored in a memory portion 297 of the host 215. Similar to the logged data 292, the logged data 297 can include the SMART attributes, the communication with a host, such as read and write operations, together with characteristics of the data associated with the read and write operations. In addition, a host logging can be included, which resides in the host and logs data and commands generated by the host.

In some embodiments, the present invention discloses a software for analyzing logged data from a solid state drive. An analyzing software, e.g., a program, can be used to analyze the logged workload from the solid state drive. The analyzing software can be run from the solid state drive, e.g., the logged data can be analyzed directly from the solid state drive, or from the host, e.g., the logged data can be sent to the host to be analyzed, or if the logged data is already at the host, the host can access and analyze the logged data.

For example, the analyzing software can be loaded to a controller, such as an operating controller of the solid state drive or a special controller for analyzing operations. The analyzing software can be stored in the logging module or can be stored in a memory portion in the solid state drive. The analyzing software can be a standalone software, running independent of the operating software of the solid state drive. The analyzing software can be an integrated part of the operating software of the solid state drive, e.g., including subroutines or modules that can be called from the operating software.

The analyzing software can be loaded to the host, for example, to use the computing power from the host. The analyzing software can retrieve the logged data from the solid state drive for the analysis. Alternatively, the logged data can be sent to the host, for example, by the logging software.

The analyzing software can be configured to assess the operations, for example, to generate data related to a life time expectancy or a performance of the solid state drive. The analyzing software can also be configured to assess the effectiveness of the operating software of the solid state drive. For example, using the stream of data, e.g., read data from the solid state drive and write data to the solid state drive, the behavior of the solid state drive, characterized by the logged data, can be evaluated. Better algorithms can be proposed and installed to the solid state drive to improve the life expectancy or performance of the solid state drive. The improvement is based on actual data, thus the new operating software can be optimized for the actual operation of the solid state drive. For example, a solid state drive can be first implemented with a generally optimized operating software, e.g., an operating software that is optimized for the most common scenario, and not necessarily optimized for the current workload. Using the current workload, the operating software of the solid state drive can be changed to best suit the current workload. The process can be continued, e.g., a new operating software can be implemented when the workload changes.

In some embodiments, the present invention discloses systems and methods to enhance operations of a solid state drive using actual history of the solid state drive. For example, the history of the solid state drive can be logged by a logging module of the solid state drive, and which can be analyzed to obtain the characteristics of the solid state drive.

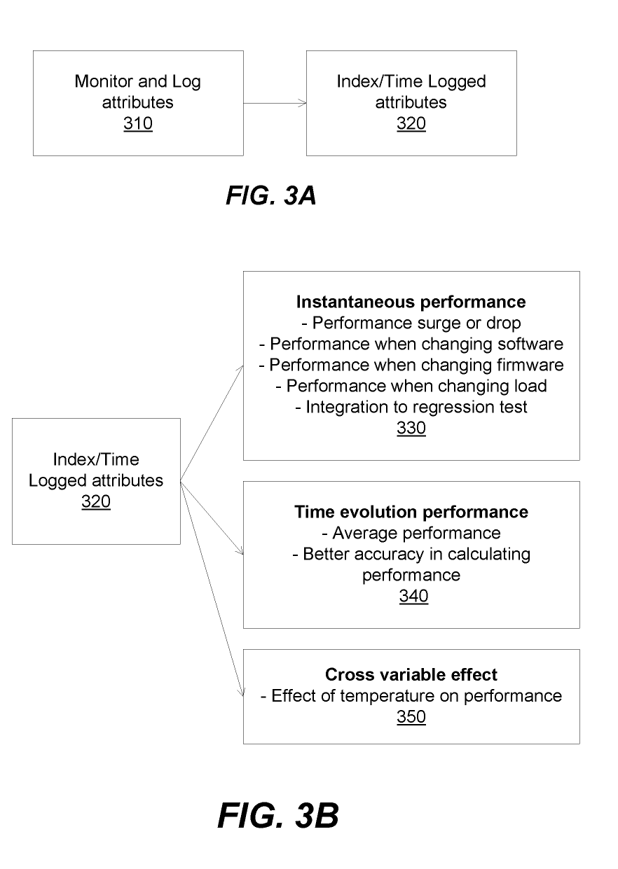

FIGS. 3A-3B illustrate operations of a solid state drive according to some embodiments. In FIG. 3A, data 310 can be monitored and logged by the solid state drive. The data can include attributes or indicators, generated from a monitor program, such as SMART program. For example, the data can include error rates, such as raw read error rate, which is the error rate relative to the number of sectors read in the current power cycle, soft read error rate, which tracts the number of correctable Error Correction Code (ECC) errors, uncorrectable soft read error rate, which is the number of soft read errors that cannot be fixed on-the-fly and requires deep recovery. The data can include error counts, such as reported I/O error detection code errors, which tracks the number of I/O errors encountered during reads from flash memory, reported uncorrectable errors, which tracks the number of uncorrectable error events reported back to the host for all data access commands, ECC on-the-fly error count, which tracks the number of uncorrectable ECC errors. The data can include failure counts, such as program fail count, which counts the number of flash program failures, erase fail count, which counts the number of flash erase failures. The data can include retired block count, a percentage of the retired blocks over the spare blocks at manufacturing time, or a percentage of the remaining spare block over the spare blocks at manufacturing time. The retired block count can tract the number of retired blocks. The data can include reserve (or spare) block count, which is the number of reserve flash memory blocks. The data can include a number of power-on hours, which shows the total or accumulated count of hours in the power-on state. The data can include a number of memory erase, e.g., the erase count or the program/erase cycles, which counts the accumulated number of memories erased across the entire drive over the life of the drive. The data can include wear range delta, which provides a value equal to the difference between the maximum worn flash block and the least worn flash block. The data can include temperature, which reports the temperature inside the solid state drive housing. The data can include SSD life left, which indicates the approximate SSD life left, in term of program/erase cycles (pe cycles) or flash block currently available for use. The SSD life left value can be calculated as a ratio of the remaining pe cycles over the rated pe cycles. The SSD life left attribute can be calculated as a ratio of the remaining spare or reserve block over the spare or reserve blocks at manufacturing time. Typically, the pe cycles can dominate this attribute until the end of life when the defects, e.g., the usage of spare or reserve blocks, starts to play a larger role. The data can include the number of reads from the SSD or writes to the SSD, accumulated over the life of the SSD.

The monitored attributes can be periodically logged 320. The monitored attributes 310 can be logged at regular index intervals to formed index logged attributes 320, such as at a regular number of writes written to the memories of the solid state drive. For example, at a first data logged, the logged attributes can include the accumulated number of writes to the SSD. When the number of writes increases to a new write number, e.g., having a constant write increment (which can be considered as an index interval), the attributes can be logged again.

The monitored attributes can be logged at different times. And the index intervals can be the difference between the accumulated writes at a subsequent logged data and the accumulated writes at a previous logged data.

The monitored attributes 310 can be logged at regular time intervals to formed time logged attributes 320, such as at every hour or at every day. The time of the time logged data can be recorded, together with the logged attributes, thus the time logged data 320 can include the logged time together with the logged attributes. The monitored attributes can be logged at different times, together with the time at the logging process. The time intervals can be the difference between the logged time at a subsequent logged data and the logged time at a previous logged data.

FIG. 3B shows different properties which can be calculated from the index logged data or the time logged data 320. Instantaneous performance 330 of the solid state drive can be calculated from the time or index logged data 320. The instantaneous performance can be calculated using the time or index logged data, such as two or more logged data obtained at different times. For a short interval, the difference between the two logged data can be used to calculate an instantaneous property, e.g., property of the solid state drive in the short interval. The short interval can be long enough so that the difference of the logged data are statistically significant. The short interval can be short enough to be considered instantaneous.

For example, a first/second logged data at a first/second logged time can include the first/second value of erase counts, e.g., the number of erase cycles or pe cycles accumulated from the beginning of the solid state drive until the first/second logged time. The difference between the first and second values of erase counts can be considered as the amount of erase counts during the time interval between the first and second logged times. Thus the life spent of the solid state drive during the time interval is the erase count difference. If the time interval is small, for example, compared to the life time of the solid state drive, then the calculated life spent can be an instantaneous value, showing the usage of the solid state drive at the logged time. Life time expectancy can be calculated using the instantaneous value, for example, by dividing the remaining erase counts to the rate of the erase counts. This life time expectancy can be considered as the instantaneous life time expectancy, e.g., the remaining lifetime of the solid state drive for the current usage.

The instantaneous performance, e.g., properties of the solid state drive calculated at a point in time, can provide an indication of a surge or drop of performance, such as a change in performance when changing the software accessing the solid state drive, a change in performance when changing a firmware of the solid state drive, or a change in performance when changing the workload of the host that the solid state drive is coupled to. Further, the instantaneous performance can be used in regression test, such as integrated to a regression test, which can provide the performance of the solid state drive under the test conditions for a new load, new software, or new firmware. Thus variation in performance, e.g., the changes in performance for a given software, firmware or load, can be determined, allowing a comparison of different software, firmware and load. This can also offer opportunity to suggest optimization, e.g., knowing which load, which software of firmware having better or worse performance.

Time evolution performance 340 of the solid state drive can be calculated from the time or index logged data 320. The time evolution performance can be a collection of instantaneous performance, e.g., forming a graph of performance as a function of time. The time evolution performance can include the performance calculated from time evolution attributes, e.g., from graphs of instantaneous attributes as a function of time. The time evolution performance can provide a better accuracy in calculating the performance, since the calculation is based on complete graph of attributes as a function of time.

The time evolution performance can be calculated from time average values of the instantaneous attributes. For example, the rates of erase counts can change as a function of time, forming a graph of erase count rates v. time. The time evolution remaining lifetime of the solid state drive can be calculated from the average rate of erase counts, e.g., by diving the number of remaining erase counts to the average rate of erase counts.

The time evolution performance can be calculated from integrated values of the instantaneous attributes. For example, the rates of erase counts can change as a function of time, forming a graph of erase count rates v. time. A curve fitting can be used to generate a function of the erase count rates. The time evolution remaining lifetime of the solid state drive can be calculated by integrating the function of rate of erase counts.

Cross variable effect 350 of the solid state drive can be calculated from the time or index logged data 320. For example, the effect of temperature on performance can be derived from the time or index logged data 320. Since the attributes can include temperature, the other attributes of the logged data collected at a same time can be viewed as dependent on the temperature at the collected time. Using logged data for different time, a dependency of other attributes to temperature can be determined. For example, same temperature at different logged time can be used to calculate variation of the other attributes for a same temperature. Different temperature at different logged time can be used to calculate relationship of the other attributes with respect to temperature.

In some embodiments, the logged data can be collected from attributes of a monitor program, such as SMART program. This can allow a quick performance calculation of the drive behavior, together with using real data.

In some embodiments, the present invention discloses a time or index logging process, which can include logging attributes of a solid state drive at different times (for index logging process), together with optional timestamp at the logged times (for time logging process). A program, such as a monitor program, can run in a solid state drive for collecting attributes related to the operation and reliability of the solid state drive. The attributes can be periodically logged, e.g., forming attribute series collected at different times to be stored in a memory, for used in calculation of the performance of the solid state drive.

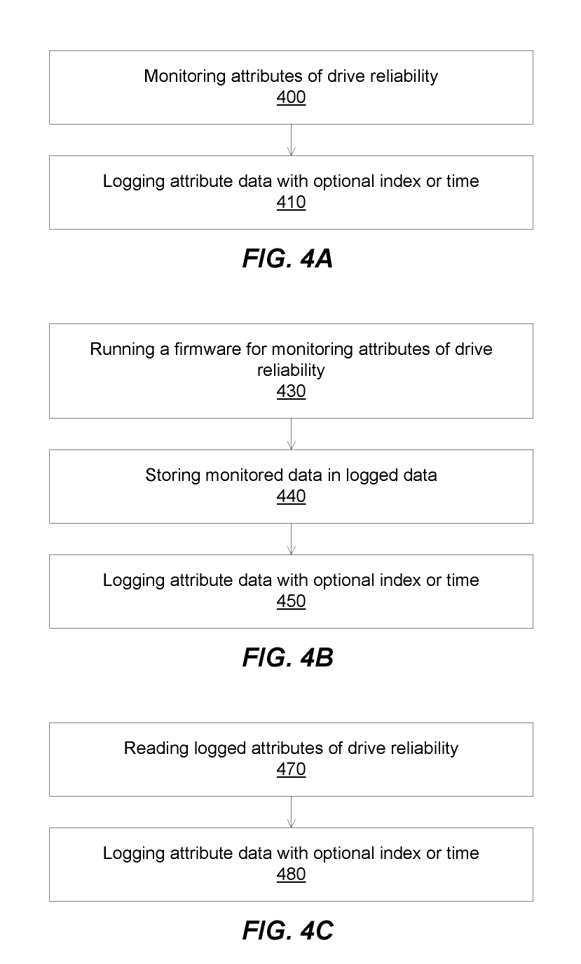

FIGS. 4A-4C illustrate flow charts for forming time or index logged data according to some embodiments. In FIG. 4A, attributes of a solid state drive can be periodically recorded. The attributes can be generated by a program for monitoring the solid state drive. The time of the recording of the attributes can also be recorded. Thus the recording process can generate a time evolution of the attributes of the solid state drive.

Operation 400 monitors attributes of a drive reliability. Operation 410 logs the attributes with optional timestamp. The attributes can be logged at different time or index intervals. The index can be an attribute, such as a number of memory written or a number of memory erased (pe cycles). For example, the attributes can be logged at constant time or index intervals, such as logged at every hour, every day, every terabyte written, or every gigabyte erased. The attributes can be logged at different time or index intervals, such as logging when the host or the solid state drive is not busy. The time/index logged attributes can be used to calculate properties of the solid state drives, including time related properties, instantaneous properties, time evolution properties, and relationships between various attributes or relationships between the properties and attributes.

In FIG. 4B, operation 430 runs a firmware for monitoring attributes of a drive reliability. The firmware can be stored in the solid state drive. Operation 440 stores the monitored attributes, either in the solid state drive or in a host coupled to the solid state drive. Operation 450 periodically logs the stored attributes with optional timestamp.

In FIG. 4C, operation 470 reads logged attributes of a drive reliability. Operation 480 periodically logs the stored attributes with optional timestamp.

In some embodiments, the present invention discloses using an existing monitor program, such as the SMART program, for monitoring and logging the attributes of a solid state drive. The solid state drives can have a monitor program, either the SMART program or a similar monitor program, for monitoring the indicators of the solid state drives for detecting and reporting the drive reliability, for example, for anticipation of hardware failures. The existing monitor program, such as the SMART program, can store the accumulated attributes, meaning the values of the attributes generated from the beginning of the solid state drives. For example, the erase count value, or the memory write value, can be the accumulated values, which are the sum of the added erase counts or the sum of the memory writes. The existing monitor program can store the current value, such as the temperature of the inside of the solid state drive.

In some embodiments, the existing monitored attributes can be periodically logged, thus can provide a time evolution attributes of the drives, together with a simplicity way of collecting attribute data. The logged data can include a series of groups of attributes, e.g., a first group of attributes logged at a first time, a second group of attributes logged at a second time, etc. Each group of attributes can include the accumulated attributes generated by the monitor program, such as the SMART program. An attribute in the group of attributes can be used as an index for the series of attribute groups. For example, the attribute of memory writes (the number of gigabytes of data written to the solid state drive), or the attribute of memory erases (the number of program/erase cycles performed on the memories of the solid state drive) can be used as an index for plotting time evolution graphs of the other attributes. For example, the number of memory erases can be formed as a function of memory writes (e.g., memory writes acting as an index for the evolution of memory erases). The logged data can be stored in the solid state drive or in the host system.

The logged data can also include the time of logging. For example, a first group of attributes can be logged, together with the time of the logging of the first group. The second group of attributes can be logged with the time of the logging of the second group. The logged time can be used as an index of plotting the time evolution graphs of the attributes. For example, the number of memory erases can be formed as a function of time.

In some embodiments, an integrated monitor program can be used, which can combine the functionality of existing monitor programs, together with the ability to store the attributes, and optionally a time stamp, at different times.

In some embodiments, a history of SMART attributes, e.g., the outputs generated by a SMART monitoring program, can be stored as a function of index or time. In other words, the SMART attributes are stored at more than 1 point in index or time. The data storing can be performed by an index or time logging process. The data can be logged and saved to the solid state drive or to a host system connected to the solid state drive. Afterwards, the stored data can be analyzed, for example, by an analyzer program which can be stored in the solid state drive or in the host system. The analyzer program can use the stored SMART history to calculate behavior and/or performance of the solid state drive, such as life expectancy and effects of workload, firmware or software on the performance or life expectancy of the solid state drive.

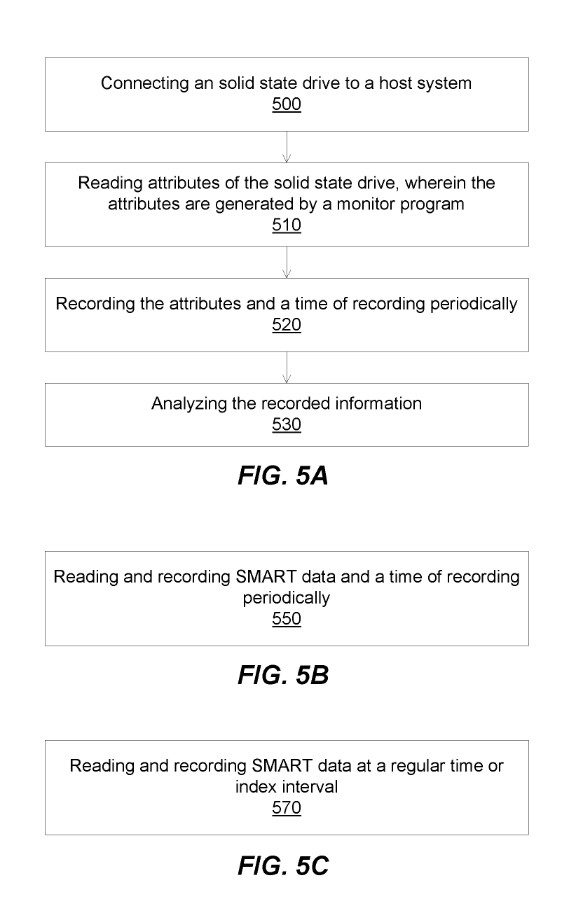

FIGS. 5A-5C illustrates flow charts for generating an index or time logging process according to some embodiments. In FIG. 5A, operation 500 connects an solid state drive to a host system. The host system can have a software running, e.g., a program executed by the host that can access the solid state drive. The solid state drive can experience a workload of the host system, e.g., the host system can write data to the solid state drive or the host system can read data from the solid state drive. The solid state drive can have a firmware running, e.g., a program executed by the solid state drive, which can include operations that are essential to the operation of the solid state drive, such as wear leveling, flash layer translation, and attribute monitoring.

Operation 510 reads attributes of the solid state drive, wherein the attributes are generated by a monitor program. The monitoring program can include a SMART program, which generates attributes or indicators related to the reliability of the solid state drive. The monitoring program can include a firmware, executed by the solid state drive.

Operation 520 records the attributes and optionally a time of recording periodically. The attributes can include a total number of bytes written to or read from the solid state drive. The attributes can include a total number of erase cycles performed on the flash memories of the solid state drive. Other attributes can be recorded, such as a wear leveling efficiency, e.g., the delta of wear leveling, or the maximum and minimum numbers of erases cycles on the flash memories. The attributes can be stored in the solid state drive, such as in a log file in the solid state drive. The attributes can be stored in the host system, such as in a log file in the host system.

Operation 530 analyzes the recorded information. Since the recorded information can be time-related information, e.g., the recorded information are recorded in different times, time related characteristics can be determined, such as a life expectancy of the solid state drive in term of time such as dates or years. In addition, snapshot characteristics of the solid state drive can be determined, allowing the distinction of different characteristics at different times, for example, due to changes in workload, software or firmware. Further, the characteristics with better accuracy can be determined, for example, through the time evolution of the collected attributes.

In some embodiments, a solid state drive can provide life acceleration parameters in SMART data, such as the number of erase cycles and/or the level of wear leveling among the flash memories. The life acceleration parameters can be periodically read, for example, by a host system. The periodicity of the reads can be determined by the host. For example, the host can decide to read the life acceleration parameters at a time period such as every hour or every day, or at a memory write period, such as every gigabyte or every ten gigabyte written to the solid state drive. The host can read the life acceleration parameters at different times, such as when the solid state drive is connected, or when an external condition is met.

In FIG. 5B, operation 550 reads and records SMART data and optionally a time of recording periodically. A solid state drive can be connected to a host system. The host system can read the SMART attributes stored in the solid state drive. The host system can optionally read the time of the SMART attribute reading. The SMART attributes and the optional time stamp can be stored, either in the solid state drive or in the host system. The SMART attribute reading and the time reading can be repeated, to generate a history of SMART attributes, or to generate a time evolution of SMART attributes as a function of time (or as a function of other attributes, such as memory written).

In FIG. 5C, operation 570 reads and records SMART data at a regular time or index interval. A solid state drive can be connected to a host system. The host system can read the SMART attributes stored in the solid state drive at a regular time or index interval. For example, the host system can read the SMART attributes at a time interval such as 1 hour, 10 hours, 1 day, or 10 days. The host system can read the SMART attributes at an index interval such as 1 gigabyte written, 10 gigabyte written, or 1% of erase cycles.

A combination of SSD and host system can be used when logging the data, e.g., reading and storing the SMART attributes. The combination of SSD and host can reduce the workload on the SSD, allowing the SSD to have improved performance. Alternatively, the method can use the SSD for logging.

The SSD can provide life acceleration parameters, e.g., attributes or indicators, in SMART data. For example, the SSD can have firmware that records attributes or indicators of the SSD characteristics, such as Raw Read Error Rate, Retired Block Count, Power-On Hours, Device Power Cycle Count, Soft Read Error Rate, Gigabytes Erased, Reserve Block Count, Program Fail Count, Erase Fail Count, Unexpected Power Loss, Wear Range Delta, Program Fail Count, Erase Fail Count, Reported I/O Error Detection Code Errors (IOEDC errors), Reported Uncorrectable Errors (URAISE), Temperature, ECC On-the-Fly Error Count, Reallocation Event Count, Uncorrectable Sector Count, SATA R-Errors Error Count, Uncorrectable Soft Read Error Rate (UECC), Soft ECC Correction Rate (UECC), Drive Life Protection Status, SSD Life Left, Available Reserved Space, Power Fail Backup Health, Lifetime Writes from Host System, Lifetime Reads to Host System. The essential parameters can include data writes, data reads, NAND consumption parameters (NAND erase count), and life remaining percentage. Other parameters can provide an indication of performance, such as the temperature of the SSD.

The SSD can be used in a host system. For example, the host system can read and record the life acceleration parameters from SSD. The host system can decide the period of the read. Each entry can be called a record. In some embodiments, the SSD can read and record the parameters. Each record can be time stamped and/or indexed. The index can be data index, e.g., an index based on the sizes of memory written. For example, each index can represent 1 GB or 100 MB of data that is written to the SSD.

When there are 2 or more records, life acceleration can be calculated, such as a remaining life expectancy of the SSD. The calculation can use the life acceleration parameters of SSD, and time stamps and/or indexes from the host. The two records can provide the characteristics and behaviors of the SSD in the time intervals specified by the time stamps. From the time interval data, other characteristics of the SSD can be calculated, such as the time expectancy can be projected from the usage of the SSD in the calculated time interval. The calculation from the SMART attributes can provide a user an estimate of remaining memory amount that can be written, and a remaining operation time of the SSD based on the real usage.

In some embodiments, the present invention discloses methods to generate time evolution of characteristics of a solid state drive. The methods can include periodically recording the characteristics of the solid state drive, together with the time of recording.

In some embodiments, the solid state drive can be connected to a host system, and the host system can perform the recording process. The characteristics can be generated by a firmware in the solid state drive, thus the host can simply read the characteristics from the solid state drive, and then perform the recording. The firmware can include a monitor program such as a Self-Monitoring, Analysis and Reporting Technology (SMART) system. The characteristics, called attributes in SMART system, can include an accumulated value of wear leveling of the memory of the solid state drive, a number or percentage of memory erased or a difference between most worn and least worn memories, a percentage of remaining erase cycles or a percentage of ease cycles performed, an inside temperature of the solid state drive, an accumulated error rate of the solid state drive, a number of remaining reserved block count or a number of retired block count, an accumulated number of memory read or memory written, an accumulated number of power on hours, or a value of remaining life in term of percentage of erase cycles or in term of reserved memory block.

The recordation process can be performed at a regular time interval, e.g., after every other days, or twice a week. The recordation process can be performed at a regular index interval. The index interval can include the time for some actions to happen. For example, the index interval can include the time in which there is a regular amount of memory is written to the solid state drive, e.g., after 1 Gbytes is written to the solid state drive.

The characteristics can be recorded in a memory portion of the solid state drive, or can be recorded in the host. After the recording, the recorded information can be analyzed, for example, to obtain information related to the behavior of the solid state drive, such as the remaining lifetime of the solid state drive.

In some embodiments, the present invention discloses using a series of logged data, e.g., a logged data set, to determine properties or behavior of a solid state drive. The series of logged data can include the time when the data is logged, thus can form a time series of logged data, e.g., a time evolution of the logged data, such as the changes of the attributes or indicators of the solid state drive as functions of time. The time evolution of the logged data can allow the determination of instantaneous properties or behavior of the solid state drive, or can allow the determination of properties or behavior of the solid state drive with better accuracy, since the calculations can be based on an extrapolation from a curve. In addition, the time evolution of the logged data can allow the expression of the properties or behavior of the solid state drive in term of time, such as the solid state drive can have a remaining lifetime of 10 days, 10 weeks, 10 months, or 10 years under the current workload, firmware and/or software.

The series of logged data can have only the data logged at different times, e.g., without including the time when the data is logged, thus can form an index series of logged data, e.g., an index evolution of the logged data. The index can be an attribute or indicator in the logged data, such as a number of writes performed on the solid state drive. For example, the index series of logged data can include changes of the attributes or indicators of the solid state drive as functions of an attribute or indicator. The index evolution of the logged data can allow the determination of instantaneous properties or behavior of the solid state drive, or can allow the determination of properties or behavior of the solid state drive with better accuracy, since the calculations can be based on an extrapolation from a curve.

In some embodiments, attributes from two or more logged data can be used to calculate properties of the solid state drive. For example, life acceleration parameters of the solid state drive, such as erase counts, and the time or index interval from the two or more logged data can be used to calculate the remaining memory amount that can be written to the solid state drive, and/or the remaining operation time of the solid state drive. The calculations can be based on the number of manufacturing determined maximum erase counts, and the consumption of erase counts in the time of index interval. Since the life acceleration parameters, e.g., the indicators collected from the solid state drive, are based on real usage of the solid state drive, the calculation of remaining lifetime can also be based on real time operation, and not from modeling of the solid state drive behavior.

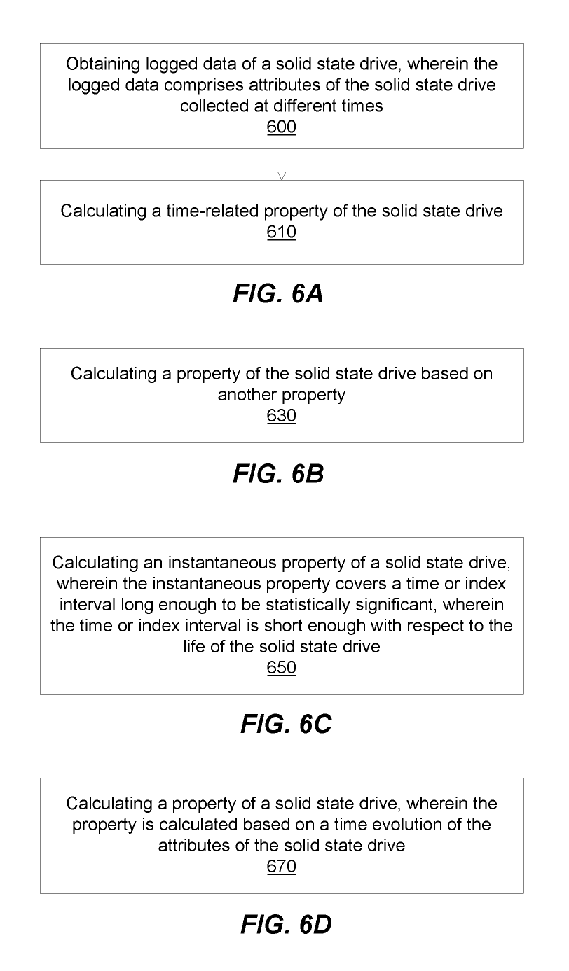

FIGS. 6A-6D illustrate flow charts for using the logged data according to some embodiments. In FIG. 6A, operation 600 obtains logged data of a solid state drive, wherein the logged data comprises parameters or attributes of the solid state drive collected at different times. The logged data can include the time of logging the data. The parameters or attributes can be logged, for example, by a firmware of the solid state drive, such as SMART process for monitoring indicators of the solid state drive.

Operation 610 calculates a time-related property of the solid state drive. The calculation can be based on at least two logged data, collected at different times, together with the time intervals of the at least two logged data. For example, an attribute, such as the erase counts, can be extracted from the logged data. The time rate of change of the attribute can be calculated based on the difference between two logged data and the time interval of the two logged data. The property can be a time related property, e.g., can be expressed as a unit of time. For example, the remaining life of the solid state drive, in term of time, can be calculated.

In some embodiments, the calculation can used adjusted attributes, e.g., the attributes at different logged data can be adjusted to be conformed to a same characteristic. For example, two logged data can be obtained at different times, and thus the temperature of the two logged data can be different. The attributes, such as the erase counts, at the second logged data (and at a second temperature) can be adjusted to be at a same temperature as the first logged data (e.g., adjusted to be at a first temperature of the first logged data). The temperature can be an attribute of the logged data, so the first and second temperatures of the first and second logged data can be obtained from the logged data.

In some embodiments, relationships between the attributes of the logged data can be obtained from the series of logged data. For example, erase counts (which is a first attribute of the logged data) can be plotted as a function of temperature (which is a second attribute of the logged data). From the plot, a relationship of erase counts and temperature can be obtained. This relationship can be used to adjust the values of erase counts, so that calculations on the erase counts, such as lifetime calculations, can be performed at a same temperature.

In some embodiments, best case, worse case, and average case scenario can be calculated for the properties of the solid state drive. In the best case scenario, the attributes are adjusted to a best performance, based on the second attribute. For example, the erase counts can be adjusted to a lowest temperature of operation of the solid state drive. The remaining lifetime of the solid state drive calculated based on the lowest temperature adjusted erase counts can be the longest lifetime, since lower temperature can provide a better performance. Similarly, the remaining lifetime of the solid state drive can be calculated based on the highest temperature or average temperature adjusted erase counts, resulting in lowest or average lifetime, respectively.

In FIG. 6B, the series of logged data can be used to calculate a property or a relationship of a parameter or an attribute based on another parameter or attribute in the logged data. Operation 630 calculates a property of the solid state drive based on another property. The property and the another property can be non-time related properties. For example, remaining lifetime can be calculated as a function of temperature. Or an error rate, such as read error rate or write error rate can be calculated as a function of temperature.

In FIG. 6C, the series of logged data can be used to calculate an instantaneous property, e.g., the property at an instant of time or index. Operation 650 calculates an instantaneous property of a solid state drive. The instantaneous property can be considered as the property of the solid state drive at a particular time, e.g., a snapshot of the property. The logged data, for example, from SMART process for monitoring attributes or indicators of the solid state drive, are typically accumulated data, e.g., the data accumulated from the beginning of the solid state drive. Thus the logged data does not provide information related to changes of behavior, such as changing workload, changing firmware, or changing software, of the solid state drive.

In contrast, the present instantaneous property can provide information at a particular point in time, which can show the changes acting on the solid state drive when compared to an instantaneous property at an earlier time. For example, the solid state drive can experience a first workload. A first instantaneous remaining lifetime calculation under the first workload can provide the remaining lifetime of the solid state drive under the first workload. A second workload then can be applied to the solid state drive. A second instantaneous remaining lifetime calculation under the second workload can provide the remaining lifetime of the solid state drive under the second workload. By comparing the first and second remaining lifetime, the effect of the first and second workloads on the solid state drive can be observed. For example, under the first workload, the remaining lifetime can be calculated to be 10 years. Under the second workload, the remaining lifetime can be calculated to be 10 days. This can show that the second workload can have a severe effect on the solid state drive.

The instantaneous property covers a time or index interval long enough to be statistically significant. The time or index interval can be short enough with respect to the life of the solid state drive. The index can be an amount of memory written to the solid state drive. The length of the time or index interval can be determined with respect to the life of the solid state drive, which can be determined by the operating time, e.g., lifetime, of the solid state drive, by the maximum number of erase count or the maximum number of writes performed on the solid state drive. Thus an index or time interval can be considered short enough when the interval is less than about 0.5, 1 or 2 percents of the lifetime, the maximum erase count or the maximum number of writes. For example, if a solid state drive has a maximum erase count of 10,000, then an interval is short enough when it includes less than about 50, 100 or 200 erase counts. An index or time interval can be considered long enough when the interval is greater than about 0.1, 0.2, 0.5 or 1 percent of the lifetime, the maximum erase count or the maximum number of writes. For example, if a solid state drive has a maximum erase count of 10,000, then an interval is long enough when it includes more than about 10, 20, 50 or 100 erase counts.

In some embodiments, the calculation of instantaneous properties can use adjusted data, e.g., logged data that are adjusted to be at a same characteristic such as at a same temperature.

In FIG. 6D, the series of logged data can be used to calculate a time or index evolution property of the solid state drive, e.g., the property is calculated based on the graph of the logged data as a function of time or index. Operation 670 calculates a property of a solid state drive. The property can be calculated based on a time or index evolution of the attributes of the solid state drive. For example, the property can be calculated based on an extrapolation of a curve fitting from the time or index evolution graphs. The extrapolation can be based on a portion of graphs, such as a current graph portion if there are big changes such as changing workloads, changing firmware or software. Thus the property calculation from the graphs can provide an estimate of the behavior of the solid state drive based on the current operation conditions. The calculation from a graph or a portion of a graph can provide better accuracy, for example, comparing to a calculation using 2 points.

In some embodiments, instantaneous values of attributes can be plotted as a function of time or index. A curve fitting can be obtained from the plot. The curve fitting can be used to calculate a property of the solid state drive. For example, instantaneous values of erase counts, e.g., the number of erase counts in a time or index interval short enough to be considered instantaneous, and long enough to be statistically significant, can be curve fitted in a period of logged data collection. The fitted curve of erase counts can be used to calculate the remaining lifetime, by integrating or extrapolating the fitted curve to a maximum number of erase counts.

In some embodiments, the graphs, and the calculation based on the graphs, can used adjusted attributes, e.g., the attributes at different logged data can be adjusted to be conformed to a same characteristic. For example, multiple logged data can be obtained at different times, and thus the temperature of some of the multiple logged data can be different. A temperature can be chosen, and the attributes, such as the erase counts, at the logged data that have a temperature different from the chosen temperature can be adjusted to be at a same temperature as the chosen temperature (e.g., adjusted to be at the chosen temperature). The temperature can be an attribute of the logged data, so the temperatures of the multiple logged data can be obtained from the logged data.

In some embodiments, relationships between the attributes of the logged data can be obtained from the series of logged data, as discussed above. For example, write error rate (which is a first attribute of the logged data) can be plotted as a function of temperature (which is a second attribute of the logged data). From the plot, a relationship of write error rate and temperature can be obtained. Since there can be multiple logged data with a same temperature, the plot can have multiple values at a same temperature. For example, in a first logged data, a first write error rate can be obtained for a first temperature, resulting in a first write error rate v. first temperature in the plot. In a second logged data, a second write error rate can be obtained for a same first temperature, resulting in a second write error rate v. first temperature in the plot. Thus there can be two values of write error rate for a same first temperature. A curve fitting can be used for calculating a relationship between the attributes, such as a relationship of write error rate v. temperature. This relationship can be used to adjust the values of write error rate, so that calculations on the write error rate can be performed at a same temperature. Other attributes, such as erase counts, can be adjusted using curve fitting, for another attribute in the logged data.

Further, instantaneous values of adjusted attributes can be curve fitted for calculating the property of the solid state drive, as discussed above. Also, best case, worse case, and average case scenario can be calculated for the properties of the solid state drive, as discussed above.

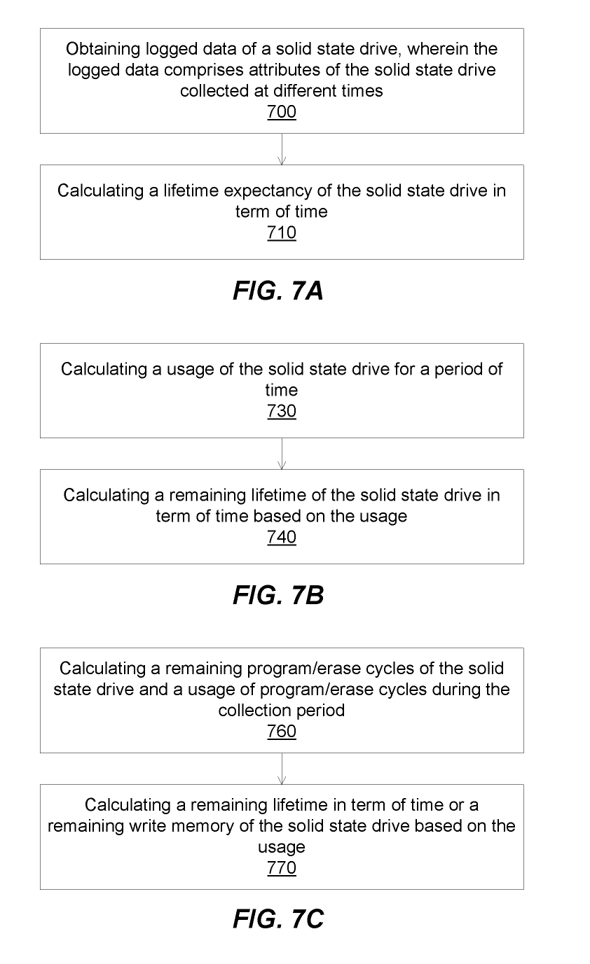

FIGS. 7A-7C illustrate flow charts for calculating a remaining lifetime of a solid state drive according to some embodiments. The flash memories of a solid state drive can have a maximum number of erase counts, sometimes called NAND erase count, NAND erase count parameter, or NAND consumption parameter. This value can be kept tracked of, either as a number of erase counts already performed, or a number of erase counts remaining from the maximum number of erase counts, such as by a SMART monitoring process in the solid state drive. A remaining lifetime of the solid state drive can be determined by extrapolating the number of erase counts already performed to the maximum erase counts, or by extrapolating the number of remaining erase counts to zero.

The flash memories of a solid state drive can have a maximum number of spare blocks of memories, sometimes called reserve block count, or spare block count. This value can be kept tracked of, such as by a SMART monitoring process in the solid state drive. A remaining lifetime of the solid state drive can be determined by extrapolating the erase counts to the maximum erase counts.

A combination of erase counts and spare blocks can be used to calculate the remaining lifetime of a solid state drive. For example, in the early stage of the solid state drive, the life of the solid state drive can be determined by the erase counts. For example, during the first 90% of the maximum erase counts, the life of the solid state drive can be determined by the consumption rate of the erase counts. In the late stage of the solid state drive, the life of the solid state drive can be determined by the spare blocks. For example, during the last 10% of the maximum erase counts, the life of the solid state drive can be determined by the consumption rate of the spare blocks. Other methodologies can be used to calculate the remaining lifetime.

In some embodiments, the logged data can contain a remaining lifetime attribute, for example, a SMART monitor process can determine and store an attribute of remaining lifetime. The remaining lifetime attribute can be calculated by the consumption of erase counts, spare blocks, a combination of erase counts and spare blocks, or by any other methodologies.

In FIG. 7A, operation 700 obtains logged data of a solid state drive. The logged data can include attributes of the solid state drive, such as a series of SMART attributes, collected at different times. The logged data can include the time of when the data are logged.

Operation 710 calculates a lifetime expectancy of the solid state drive in term of time. For example, the logged data can include an attribute of remaining life of the solid state drive. By obtaining two values of the remaining life at two different logged times, together with the time interval of the two values, a rate of remaining life v. time can be calculated, which can be used to determine a lifetime expectancy of the solid state drive in term of time. Alternatively, the consumption of erase counts or spare blocks as a function of time can be used to calculate the lifetime expectancy of the solid state drive in term of time. Instantaneous properties or time evolution properties can be used to determine the lifetime expectancy of the solid state drive in term of time.

In FIG. 7B, operation 730 calculates a usage of the solid state drive for a period of time. The usage can include the consumption of erase counts (sometimes called program/erase cycle or pe cycle), the consumption of spare blocks, or a combination of erase counts and spare blocks. The period of time can be the time difference between 2 data collections, e.g., the time interval between two data logged.

The period of time can be a time interval between two different logged times. The period of time can be can be calculated from the recorded times for the different logged times.

In some embodiments, the period of time can be selected to improve the accuracy of a property calculated from the logged data. For example, if the period of time is too short, the calculated property might be influenced by the noise in the data. Similarly, if the period of time is too long, the changes of the property can be buried. Thus the period of time can be determined with respect to the life of the solid state drive, such as by the maximum number of erase count or by the maximum number of writes performed on the solid state drive.

The period of time can be a time interval long enough so that the calculated property can be statistically significant. The period of time can be greater than about 0.1, 0.2, 0.5 or 1 percent of the lifetime, of the maximum erase count or of the maximum number of writes. For example, if a solid state drive has a maximum erase count of 10,000, then an period of time can be long enough when it includes more than about 10, 20, 50 or 100 erase counts.

The period of time can be a time interval short enough so that the calculated property does not get to be averaged. For example, if a high property value is next to a low property value, the period of time should be short enough to show the high and low values, instead of an average of the two values. The period of time can be less than about 0.5, 1 or 2 percents of the lifetime, the maximum erase count or the maximum number of writes. For example, if a solid state drive has a maximum erase count of 10,000, then an interval is short enough when it includes less than about 50, 100 or 200 erase counts.

In some embodiments, the time period can be determine from other characteristics or attributes, such as a percentage of the lifetime, a percentage of the maximum erase count (e.g., maximum number of program/erase cycles), a number of erase count (e.g., a number of program/erase cycles), a percentage of the maximum number of writes, or a number of number of writes. For example, the time period can be selected to be about 10 program/erase cycles. Different logged data, e.g., data logged at different times, can be selected so that the difference in program/erase cycles is 10. The time period can be calculated from the logged data having logged time difference of 10 program/erase cycles. The property can be calculated using the logged data, together with the time period.

Alternatively, a number of program/erase cycles can be calculated for a logged data set, e.g., data logged at different times. The logged data set can be evaluated, for example, to identify the logged data (among the logged data set) that can provide the desired program/erase cycle difference. The identified logged data can be used to calculate the time period and the property of the solid state drive.

In some embodiments, an iteration process can be performed to determine the period of time. For example, a first period of time can be selected as an initial time period. Logged data can be determined that have the time interval of the time period. The property can be calculated from the logged data. A second period of time can be selected, which is different from the first period of time. For example, a first period of time can be long, e.g., 5% of the program/erase cycles. Then a second period of time can be shorter, such as 4% or 3%. Alternatively, a short first period of time can be selected, such as 0.02% of the program/erase cycles. Then a second period of time can be longer, such as 0.04% or 0.05%. The second logged data can be determined, and the second value of the property can be calculated. The different property values can be evaluated to determined an optimum period of time, e.g. a period of time that is long enough to remove sharp noise, and short enough to be considered as instantaneous.

Operation 740 calculates a remaining lifetime of the solid state drive in term of time based on the usage. A usage of the solid state drive can be calculated for a time period. And the remaining lifetime of the solid state drive can be calculated based on the usage. For example, the remaining lifetime can be determined by a ratio of the remaining erase counts over the rate of erase count consumption. The remaining lifetime can be expressed in a unit of time.

In some embodiments, the remaining lifetime can be calculated by obtaining accumulated numbers of remaining program/erase cycles of the solid state drive at different times; calculating a usage of the program/erase cycles for the time intervals between the different times; and calculating a remaining lifetime of the solid state drive based on the usage, wherein the remaining lifetime is expressed in a unit of time.

The remaining lifetime can be calculated by obtaining two accumulated numbers of remaining program/erase cycles of the solid state drive at two different times; calculating a usage of the program/erase cycles for the time interval between the two different times; and calculating a remaining lifetime of the solid state drive based on the usage, wherein the remaining lifetime is expressed in a unit of time.

The remaining lifetime can be calculated by obtaining accumulated numbers of remaining program/erase cycles of the solid state drive at different times; calculating an average usage of the program/erase cycles for the time intervals between the different times; and calculating a remaining lifetime of the solid state drive based on the average usage, wherein the remaining lifetime is expressed in a unit of time.

The remaining lifetime can be calculated by obtaining accumulated numbers of remaining program/erase cycles of the solid state drive at different times; calculating usages of the program/erase cycles for the time intervals between the different times; curve fitting the usages with the time intervals; and calculating a remaining lifetime of the solid state drive based on an integration the fitted curve of usages over time intervals, wherein the remaining lifetime is expressed in a unit of time.

In FIG. 7C, operation 760 calculates a remaining program/erase cycles of the solid state drive and a usage of program/erase cycles during the collection period. The usage of program/erase cycles can be determined as the difference of the collected remaining program/erase cycles over the time interval. The usage of program/erase cycles can be determined as the difference of the collected remaining program/erase cycles over the memory interval, e.g., the amount of memory writes occurred during the time interval.

Operation 770 calculates a remaining lifetime in term of time or a remaining write memory of the solid state drive based on the usage. For example, the remaining lifetime can be determined by a ratio of the remaining erase counts over the rate of erase count consumption.

In some embodiments, “Remaining NAND life” can be calculated using data from SSD, which can be calculated as a product of Total NAND endurance on current SSD and Life remaining percentage. “SSD Write factor” on SSD can be calculated using data from SSD, which can be calculated as a division of NAND Erase Count Parameter and Host Write Amount. Remaining Terabyte Written can then be calculated. For example, a host can use from calculations in previous operations, together with timestamps and indexes from the records, to predict Remaining Terabyte Written, to estimate usage per day, and to estimate remaining time of the SSD.

In some embodiments, the present invention discloses methods and systems to form correlations or relationships between the characteristics, e.g., attributes collected by a firmware such as SMART program, of a solid state drive. The relationships can provide information about the interdependency of the characteristics, or the effects of one characteristic on another characteristic, such as error rates of the solid state drive as a function of operating temperature. The relationships can allow property calculation compensation, for example, by correcting or adjusting the characteristics for a same calculation condition. For example, the logged data set, which includes multiple logged data, with each logged data collected at a different time, can include data at different temperatures. Each logged data can include multiple characteristics (or attributes or indicators or parameters, which can be used interchangeably in the present specification), of the solid state drive, together with the time that the characteristics are logged. The relationships between the characteristics and the operating temperature can allow a correction or adjustment of the characteristics to a same temperature, which then can ensure that the data used in the property calculation are at a same temperature.

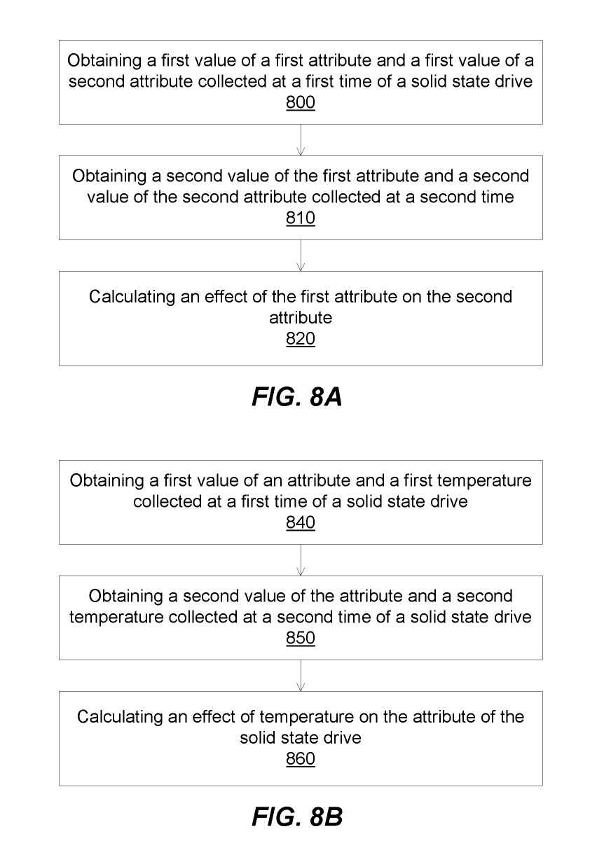

FIGS. 8A-8B illustrate flow charts for forming relationships between various characteristics, attributes or parameters of a solid state drive according to some embodiments. The relationships can be between characteristics or attributes of the solid state drive, such as the effects of temperature, program/erase cycles, reserved or spare memory on the performance, error rates, or remaining lifetime. For example, the performance, the error rates, and the remaining lifetime can be formulated as a function of the operating temperature of the solid state drive. The program/erase cycles can be formulated as a function of the error rates. The program/erase cycles can be formulated as a function of the reserved or spare memory.

The relationship can be formed based on the data collected and recorded at different times, e.g., the multiple logged data in a logged data set. For example, a SMART monitoring program can collect attributes such as read error rates, write error rates, number or percentage of program/erase cycles, wear leveling characteristics, operating temperature, etc. Logged data at different logged times can be recorded, which can be used to provide cross relationships between these attributes.

In some embodiments, the relationships can be formed between different properties, e.g., data calculated from the attributes, and between properties and attributes. For example, a remaining lifetime can be an attribute, e.g., calculated and stored by a firmware such as SMART. The remaining lifetime attribute can be an average value, e.g., calculated from the usage of program/erase cycles for the total time of operation of the solid state drive. The remaining lifetime attribute can have error, especially if there are large changes to the operating conditions of the solid state drive. For example, during the first year, the solid state drive might not be used much, so there is a low consumption of program/erase cycles. During the second year, the solid state drive might be used extensively, so there is a high consumption of program/erase cycles. The remaining lifetime attribute can be calculated using the average of high and low consumption of program/erase cycles per year. Thus the value of the remaining lifetime attribute can be greatly over-estimated if the solid state drive is continued to be used extensively.

In contrast, attributes from the logged data set can be used to calculate an instantaneous remaining lifetime, which can be considered a calculated property of the solid state drive. The remaining lifetime property, e.g., the remaining lifetime calculated from other attributes in the logged data set, can be more accurate than the remaining lifetime attribute, e.g., the remaining lifetime values present in the logged data set, since it reflects an instantaneous value, instead of a time average value.

FIG. 8A shows a process for obtain a relationship between two characteristics, such as attributes generated from SMART process. The relationships can be determined from 2 points, e.g., a rate of change can be calculated from the 2 points, and data can be interpolated or extrapolated from the rate of change, e.g., the rate of change can be constant. For example, a first collected data at a first time can include a first error rate and a first operating temperature. A second collected data at a second time can include a second error rate and a second operating temperature. A rate of change of the error rate can be calculated as a ratio of the difference between the first and second error rates over the difference between the first and second temperatures. A third error rate value at a third temperature can be obtained from the rate of change of the error rate, e.g., the rate of change between the first and third data points can be the same as the rate of change between the first and second data points.

Operation 800 obtains a first value of a first attribute and a first value of a second attribute collected at a first time of a solid state drive, e.g., values for the first second attributes can be obtained from the logged data of the first time. For example, a first attribute can be the program/erase cycles y. A second attribute can be the write error rate x. From a first logged data, e.g., logged data obtained at the first time, a first value y₁ of 30% and a first value x₁ of 2% can be obtained for the first logged data.

Operation 810 obtains a second value of the first attribute and a second value of the second attribute collected at a second time. For example, for a second logged data, a second value y₂ of 33% (for the first attribute of program/erase cycles) and a second value x₂ of 4% (for the second attribute of write error rate) can be obtained for the second logged data.

Operation 820 calculates an effect of the first attribute on the second attribute. The effect can be a relationship between the first and second attributes. For example, the first attribute can be formulated as a function of the second attribute. In the above example, the relationship between the program/erase cycle y and the write error rate x can be formulated as

$$\frac{x - {x}_{1}}{y - {y}_{1}} = \frac{{x}_{2} - {x}_{1}}{{y}_{2} - {y}_{1}}$$

The relationships can be determined from more than 2 points, e.g., a curve fitting can be calculated from the multiple data points, and data can be calculated from the fitted curve. For example, a first collected data at a first time can include a first error rate and a first operating temperature. A second collected data at a second time can include a second error rate and a second operating temperature. A third collected data at a third time can include a third error rate and a third operating temperature. The first, second, and third temperatures can all be different temperatures, or some of them can be the same temperature.

A fitted curve of the error rate can be calculated as a curve fitting for the three data points of error rates and temperatures. For example, a linear regression fitting can provide a fitted curve for the three data points. Error rates at other temperatures can be determined from the fitted curve.

FIG. 8B shows a process for obtain a relationship of a characteristic with the operating temperature. The relationships can be determined from 2 points, e.g., a linear relationship between the 2 points. The relationships can be determined from more than 2 points, e.g., a curve fitting can be calculated from the multiple data points, and data can be calculated from the fitted curve.

Operation 840 obtains a first value of an attribute and a first temperature collected at a first time of a solid state drive. For example, a first attribute can be the program/erase cycles, and a first value y₁ of 30% can be obtained for a first logged data. A second attribute can be the operating temperature, and a first value T₁ of 25C can be obtained for the first logged data.

Operation 850 obtains a second value of the attribute and a second temperature collected at a second time of a solid state drive. For example, for the second logged data, a second value y₂ of 33% (for the first attribute of program/erase cycles) and a second value T₂ of 30C (for the second attribute of operating temperature) can be obtained.

Operation 860 calculates an effect of temperature on the attribute of the solid state drive. The effect can be a relationship between the first and second attributes. For example, the first attribute can be formulated as a function of temperature. In the above example, the relationship between the program/erase cycle y and the operating temperature T can be formulated as

$$y - {y}_{1} = \frac{{y}_{2} - {y}_{1}}{{T}_{2} - {T}_{1}} ( T - {T}_{1} )$$

In some embodiments, the present invention discloses methods and systems for calculate properties for a solid state drive under similar conditions. Data, e.g., characteristics of a solid state drive, can be recorded at different times, e.g., forming a logged data set, which can allow the calculation of the solid state drive properties, such as instantaneous properties and property values in unit of time. The recording conditions can be different at the different recording times, for example, the operating temperature can change from one recorded time to another recorded time.

In some embodiments, the recorded data, e.g., the characteristics in the logged data set, can be adjusted or corrected to compensate for the changes in the recorded conditions. For example, a first logged data in a logged data set can be recorded at a first temperature. The recorded temperature can be stored in the logged data as an attribute of the logged data. A second logged data in the logged data set can be recorded at a second temperature. If the first and second temperatures are not the same, properties calculated from the attributes in the logged data set can be somewhat inconsistent, since the attributes are recorded at different temperatures.

In some embodiments, the inconsistent data can be removed from the logged data set. For example, first, second, fourth and fifth logged data can be recorded at a same temperature, and third logged data can be recorded at a different temperature. The third logged data can be removed from the calculation of properties of the solid state drive, thus providing property values for the recorded temperature.

In some embodiments, the logged data set can be ordered into multiple logged data subsets, with each logged data subsets having a same operating temperature. A property of the solid state drive can be calculated based on a logged data subset, allowing the property to be calculated at a same temperature. Different values of a same property can be calculated for different temperatures, e.g., using different logged data subsets, which can generate best case scenario, e.g., property calculated for a lowest temperature, worst case scenario, e.g., property calculated for a highest temperature, average case scenario, e.g., property calculated for an average temperature or property calculated as an average of the various case scenarios.

In some embodiments, the logged data set can be adjusted to be at a same temperature. For example, the logged data set can include values of program/erase cycle collected at different times, and possibly at different temperatures. A relationship of the program/erase cycle and temperature can be determined, for example, from a linear proportion calculation based on 2 data points, or from a fitted curve based on a multiple data point curve fitting. The relationship can be used to adjust the values of program/erase cycles in the logged data set to be values of program/erase cycles at the desired temperature.

For example, a logged data at a first recorded time can include a value of program/erase cycle and an operating temperature. Thus the value of program/erase cycle for the first recorded time are obtained at the recorded operating temperature. This value of program/erase cycle can be adjusted to be at a different temperature by using the relationship of program/erase cycle and temperature. Using the relationship, values of program/erase cycle in different recorded times, e.g., in different recorded temperature, can be adjusted to be at a same temperature. A property of the solid state drive, e.g., the remaining lifetime, can be calculated using adjusted values of program/erase cycle, e.g., using values of program/erase cycle at different recorded times that are adjusted to a same temperature.

Multiple values of the property, such as multiple values of remaining lifetime, can be calculated for different temperatures. An average value of the remaining lifetime can be calculated from these multiple values. Also, best case and worst case scenarios can be obtained, e.g., best and worst remaining lifetime can be determined, for example, by using data at lowest and highest temperature, respectively.

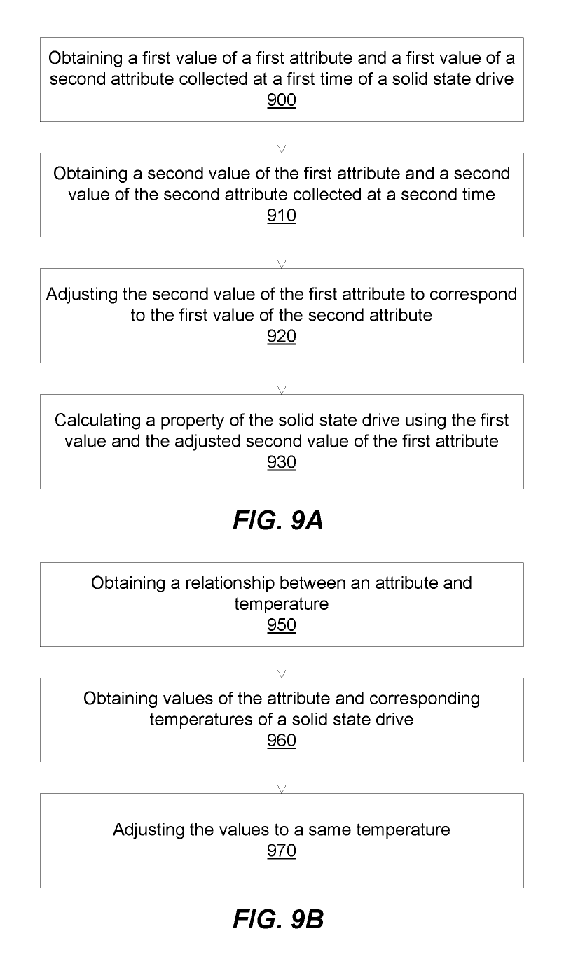

FIGS. 9A-9B illustrate flow charts for calculating properties at same conditions according to some embodiments. In FIG. 9A, logged data from different recorded times are obtained, and then adjusted to be at a same condition. The adjusted values can be used to calculate a property of the solid state drive.

Operation 900 obtains a first value of a first attribute and a first value of a second attribute collected at a first time of a solid state drive. For example, the first attribute can be program/erase cycle, and the second attribute can be remaining reserve or remaining spare memory blocks. A first value of program/erase cycle and a first value of remaining reserve memory blocks can be obtained from the logged data collected at the first recorded time.

Operation 910 obtains a second value of the first attribute and a second value of the second attribute collected at a second time. A second value of program/erase cycle and a second value of remaining reserve memory blocks can be obtained from the logged data collected at the second recorded time.

Operation 920 adjusts the first or second value of the first attribute to correspond to the second or first value of the second attribute, respectively. If the first and second values of remaining reserve memory blocks are different, the first value of the program/erase cycle can be adjusted to reflect the value of program/erase cycle at the second value of remaining reserve memory blocks. Alternatively, the second value of the program/erase cycle can be adjusted to reflect the value of program/erase cycle at the first value of remaining reserve memory blocks.

In some embodiments, a relationship linking the program/erase cycle with the remaining reserve memory blocks can be calculated from the logged data set. The relationship can be used to adjust the values of the program/erase cycle as discussed above.

Operation 930 calculates a property of the solid state drive using the values of the first attribute at a same value of the second attribute. For example, the first value and the adjusted second value of the first attribute can be used to calculate a property of the solid state drive at the first value of the second attribute. The adjusted first value and the second value of the first attribute can be used to calculate a property of the solid state drive at the second value of the second attribute.

In FIG. 9B, logged data from different recorded times are obtained, and then adjusted to be at a same temperature. The temperature adjusted values can be used to calculate a property of the solid state drive, such as a remaining lifetime.

Operation 950 obtains a relationship between an attribute and temperature. The relationship can be calculated from the logged data set, for example, by a linear calculation using 2 data points, or by a curve fitting for the attribute values and the temperature values in the logged data set.

Operation 960 obtains values of the attributes and corresponding temperatures of a solid state drive. The values of the attributes and the corresponding temperatures can be obtained from the logged data set, e.g., each value of the attribute and the corresponding temperature can be obtained from a logged data of the logged data set.

Operation 970 adjusts the values of the attributes to a same temperature. For example, a desired temperature can be determined, and the values of the attributes for the logged data set can be adjusted to be at the desired temperature using the relationship. Different sets of values can be generated for different temperatures. Different property values can be calculated from the different sets of values.

In some embodiments, the present invention discloses methods and system for calculating an instantaneous property of a solid state drive. An instantaneous property can be considered as the property of the solid state drive at an instant in time. The instantaneous property can be calculated from a time or index curve, e.g., using a curve fitting on multiple discrete values of the property or characteristics. For example, from the fitted curve, a value for the property at a particular time or index can be obtained substituting the time or index to the fitted curve. Other operations can be used, such as derivative or integral. For example, a curve fitting can be used for the numbers of erase counts as a function of time. The instantaneous value of consumed erase counts can be obtained by taking derivative of the fitted curve.

Alternatively, the instantaneous property can be calculated in a time or index interval suitable to be considered instantaneous, e.g., a time or index interval small enough as not to miss changes in the property behavior, and a time or index interval large enough as to observe changes in the property behavior.

The time or index interval for calculating an instantaneous property can be short enough so that the characteristics in the interval can exhibit a linear behavior or an approximate linear behavior. The property can be calculated from the characteristics. For example, in piece-wise linear characteristics, if the interval is selected so that the characteristics increase or decrease linearly within the interval, than the interval can be short enough. If the interval is selected so that the characteristics perform a non-linear change, such as increasing and then decreasing, or increasing slowly and then increasing quickly, then the interval is not short enough.

In non linear characteristics, e.g., the characteristics behavior is non linear, if the interval is selected so that the characteristics deviate significantly from a linear approximation, then the interval is not short enough. For example, if the characteristics increase and then decrease in an interval, then the interval is not short enough. If the characteristics increase slowly then increase quickly in an interval, then the interval is not short enough. If the characteristics non-linearly increase slowly in an interval, then the interval can be considered short enough if the non-linearly increase is less than a criterion, such as less than 10%, less than 5% or less than 2%. The criterion can be related to an accuracy of the property calculation.

In some embodiments, an iteration process can be used to determine whether or not the interval is short enough, or to determine an optimum short enough interval. For example, an initial interval can be selected, and the characteristic behavior in the selected interval is evaluated. If the change of the characteristics in the interval meets the criterion, e.g., exhibiting a linear or an approximate linear behavior, then the interval is considered short enough. The interval then can be shortened or lengthened, depending on the previous result, and the new interval is re-considered. When two successive intervals show a change, e.g., from short enough to not short enough, then the short enough interval can be considered an optimum short enough interval.

The time or index interval for calculating an instantaneous property can be long enough so that the characteristics can exhibit some changes, e.g., some properties can be calculated as functions of some characteristic changes. The characteristic changes can be calculated as a rate of change of the characteristics, e.g., the ratio of the change in the characteristics over the interval. If the interval is a time interval, then the rate of change of the change of the characteristics over time. If the interval is an index interval, such as the amount of memory written to the solid state drive, then the rate of change of the change of the characteristics over written memory.

For example, a remaining lifetime of the solid state drive can be calculated from the rate of change of erase counts (also called program/erase cycles). Flash memories can have a maximum number of erase counts, for example, determined by the manufacturing process. Thus, from the rate of change of the erase counts, the remaining lifetime of the solid state drive can be determined, e.g., by projecting to the time needed to reduce the number of erase counts to zero from the erase count usage, e.g., from the rate of change of erase counts.

To calculate the remaining lifetime, an interval can be considered not long enough if the number of erase counts does not change within the interval. For example, the remaining lifetime can be calculated from the erase count using the following formula

maximum number of erase counts=rate of change*remaining lifetime

Thus if the number of erase counts does not change, then the rate of change is zero, and the remaining lifetime cannot be calculated.

In some embodiments, the interval can be considered long enough if there is a change in the characteristics of the logged data set that can be used in the calculation of the properties. For example, the calculation of remaining lifetime uses the characteristic of number of erase count, thus the interval between the logged data used in the calculation of remaining lifetime will need show changes in the erase counts, to be considered long enough. Other properties can require changes in different characteristics. For example, calculation of read or write error behavior will use the characteristics of read and write error rates, and thus a long enough interval would require that the read and write error rates exhibit some changes.

In some embodiments, the interval can be considered long enough if the change in the characteristics of the logged data set that can be used in the calculation of the properties can meet an error criterion, e.g., an uncertainty criterion, in the calculation of the properties. For example, a previous value can be L₁=10 unit, it would have an uncertainty of 0.5, since any value between 9.5 and 10.5 would be round to 10. If the previous value is changed to a currently value of L₂=11 unit, it would also have an uncertainty of 0.5. The unit can be the number of digits used to store the value

An error or uncertainty associated with the change, e.g. from the previous value to the current value can be calculated from the uncertainty of these values. For example, the rule of adding in quadrature can be used to calculate the error in the difference. Thus the error associated with the value change can be calculated as

E=\sqrt{0.5²+0.5²}=0.5\sqrt{2}=0.7

A relative error associated with the change can be E/(L₂−L₁), which is 70%. Thus any property calculated from this change would have at least an uncertainty of 70%. To reduce the error, higher value of change would be used.

In some embodiments, the interval can be considered long enough is the characteristic changes can meet an error or uncertainty criterion. For example, in the above example, if an error of 7% is used, then the change in value would be at least 10.

In some embodiments, an iteration process can be used to determine whether or not the interval is long enough, or to determine an optimum long enough interval. For example, an initial interval can be selected, and the characteristic behavior in the selected interval is evaluated. If the change of the characteristics in the interval meets the criterion, e.g., exhibiting a change in a characteristic, or the characteristic change can provide acceptable error in the calculation of the property, then the interval is considered long enough. The interval then can be shortened or lengthened, depending on the previous result, and the new interval is re-considered. When two successive intervals show a change, e.g., from long enough to not long enough, then the long enough interval can be considered an optimum long enough interval.

In some embodiments, specific lengths for the interval can be used. For example, the interval can be less than about 0.5, 1 or 2 percents of the lifetime, the maximum erase count or the maximum number of writes. The interval can be greater than about 0.1, 0.2, 0.5 or 1 percent of the lifetime, the maximum erase count or the maximum number of writes.

In some embodiments, the instantaneous property can be calculated by the logged data surrounding the interval, e.g., the logged data collected at the beginning of the interval and the logged data collected at the end of the interval. The instantaneous property can be calculated by the logged data within the interval, e.g., the difference between the logged data collected at the end of the interval and the logged data collected at the beginning of the interval. For example, a remaining lifetime can be calculated from the change in erase counts, e.g., the consumption of erase counts during the interval. Assuming that erase count consumption is constant, a remaining lifetime can be calculated, based on the remaining number of erase counts available for the solid state drive.

In some embodiments, the instantaneous property can be calculated by the logged data in multiple intervals. A curve fitting can be used to form a fitted curve, showing the behavior of the characteristics as a function of time or index. For example, the consumptions of erase counts in multiple intervals can be curve fitted to generate a curve of the usage of erase counts at different times or indexes. An integration of the erase count usage curve can be used to determine the time or index when the erase count consumption reaches the remaining number of available erase counts.

Alternatively, the values of consumed erase counts at multiple logged data can be curve fitted to generate a curve of the consumed erase counts or remained erase counts at different times or indexes. The remaining lifetime and index can be determined by calculating from the curve of the consumed erase counts or remained erase counts, showing when the consumed erase counts reach the maximum number of erase counts or when the remained erase counts reach zero.

In some embodiments, the instantaneous property calculations can use the adjusted values of the characteristics. The characteristic values in the logged data set can be collected at different times, thus at different conditions, such as at different operating temperatures. An adjustment of the characteristic values can correct the condition difference, allowing the property calculations to be calculated at same conditions by using the adjusted characteristic values.

In some embodiments, the adjustment can be performed using relationships between the characteristics. For example, a curve fitting of erase counts as a function of temperature, with values of erase counts and temperature collected from logged data set, can form a relationship between the erase counts and temperature. The relationships can allow changing the values of the characteristics to be at same conditions for the calculations of properties.

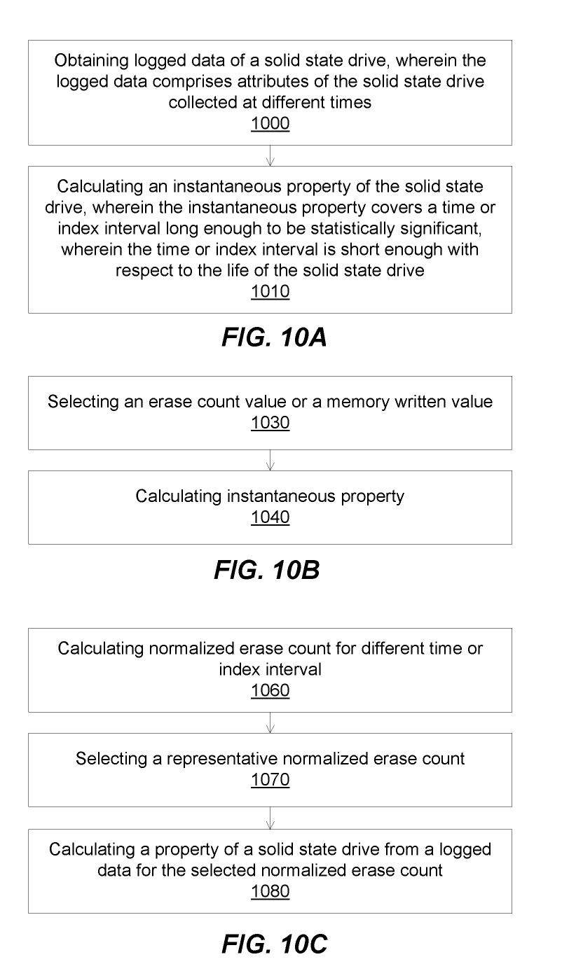

FIGS. 10A-10C illustrate flow charts for calculating instantaneous properties according to some embodiments. The instantaneous properties can provide behaviors of the solid state drive at any instant in time.

The instantaneous properties can be the characteristics, e.g., straits, attributes, indicators, parameters, of the solid state drive at any instant in time. In some embodiments, the properties can include data collected in logged data of the logged data set.

For example, the properties of erase count is related to the number of flash memory erase, e.g., the program/erase cycles of the flash memory in the solid state drive. A solid state drive can record an accumulated value of erase counts, e.g., the total number of erase counts accumulated from the beginning of the solid state drive.

An instantaneous erase count property can be the number of erase counts consumed at an instant in time. The instantaneous erase count consumption property can be calculated as a derivative of a fitted curve of the accumulated erase counts v. time or index. Alternatively, an instantaneous erase count consumption property can be calculated as a difference between the final and the beginning accumulated erase counts in a time or index instantaneous interval, with the instantaneous interval being an interval short enough to be considered as instantaneous, and long enough to be statistically significant. The instantaneous erase count consumption property can also be calculated from the values of accumulated erase counts in multiple time or index intervals, with the intervals short enough to be considered as instantaneous, and long enough to be statistically significant.

The properties of lifetime is related to the remaining time of solid state drive (e.g., the time that the solid state drive can still be in operation) or the remaining index of solid state drive (e.g., the index can be the number of memories written to the solid state drive, and thus the remaining index can be the amount of memories that can still be written to the solid state drive). A solid state drive can calculate and record an operation-average lifetime, e.g., a remaining lifetime typically expressed in an index (such as number of memory written to the solid state drive). The operation-average lifetime can be calculated as an average value for the duration of the solid state drive operation. For example, the operation-average lifetime can be calculated from an accumulated erase counts and an accumulated memory written to the solid state drive.

An instantaneous lifetime property can be the remaining time of index at an instant in time, e.g., the remaining time or index calculated using the instant behavior, optionally with the past behavior of the solid state drive. The instantaneous lifetime property can be calculated using the instantaneous erase count, such as using the instantaneous erase count to project the remaining time for the complete consumption of all the ease counts. For example, an instantaneous erase count can be determined for an instantaneous interval, and the remaining lifetime can be determined as a ratio of the remaining erase counts over the instantaneous erase count. The remaining lifetime can be calculated as an integral of a function of instantaneous erase count v. time or index.

The instantaneous properties of the solid state drive can provide better accuracy, together with identifying changes in behavior and performance of the solid state drive, e.g., due to changes in load conditions, or firmware or software changes.

FIG. 10A shows a flow chart for determining instantaneous properties of a solid state drive. Operation 1000 obtains logged data of a solid state drive, wherein the logged data comprises attributes of the solid state drive collected at different times. Operation 1010 calculates an instantaneous property of the solid state drive. The instantaneous property can be a property at an instant in time or index. The instantaneous property can be a property in a time or index interval long enough to be statistically significant, and short enough to be considered instantaneous, for example, short enough with respect to the life of the solid state drive, such as less than 1% of maximum amount of memory can be written, or 1% of maximum erase counts.

FIG. 10B shows a flow chart for determining instantaneous properties of a solid state drive based on erase count characteristic. The instantaneous properties can include remaining lifetime in unit of time or index. Operation 1030 selects an erase count value or a memory written value. For example, the number of erase count can be more than 1, 5, 10, or 100 of a total erase counts. The number of erase count can be more than 0.1%, 0.2%, 0.5%, 1% of the total erase counts.

Operation 1040 calculates instantaneous property, such as lifetime, using the selected erase count as an interval for determining the instantaneous criterion. For example, logged data can be obtained, and attributes of the logged data within intervals specified by the selected erase count can used to calculate the instantaneous properties.

FIG. 10C shows a flow chart for calculating instantaneous properties using an iteration process. The iteration process can provide a proper interval, e.g., an instantaneous interval which is long enough to be statistically significant, and short enough to be considered instantaneous. In some embodiments, calculating an instantaneous property can mean getting different values of attributes for different time intervals, then select one that is a representative of instantaneous.

Operation 1060 calculates values of attributes, such as erase count, for different time or index intervals. Operation 1070 selects a representative erase count. The representative erase count can be obtained by an iteration process, such as getting small changes, e.g., less than 1% change, getting within a percentage, e.g., within 10%, of a stable value, or getting smaller changes, such as getting a change less than 10% from a previous larger time interval.

Operation 1080 calculates a property of a solid state drive from a logged data set for the representative erase count. For example, logged data can be obtained, and attributes of the logged data within the representative interval can used to calculate the instantaneous properties.

In some embodiments, the instantaneous properties can be calculated using adjusted data in the logged data set. Logged data in the logged data set can be collected at different times, thus can be at different conditions, such as at different operating temperature. The data in logged data set can be adjusted, for example, to be at a same temperature, before being used for calculating the instantaneous properties. The adjustment can use relationships between attributes in the logged data set, as discussed above.

In some embodiments, the present invention discloses methods and systems to calculate the effect of software, firmware or load on a solid state drive. A solid state drive can have flash memories, which can be degraded and replaced after a certain time in operation. For example, the operation time of a solid state drive can be directly related to a maximum number of program/erase cycles (sometimes called erase counts) of the flash memories. Different loads, firmware programs, or software programs can have different effects on the solid state drive, such as increasing or decreasing the number of program/erase cycles, which can change the operation time, e.g., the lifetime, of the solid state drive.

In some embodiments, the present invention discloses methods and systems for calculating a local instantaneous property, e.g., a property of the solid state drive based only on the instant time, or based on a certain period of time. The local instantaneous property, e.g., the calculated property on a period of time, can provide an indication of the effects of the load, firmware or software on the solid state drive. Multiple periods of time, or a long period of time can be used to calculate the local instantaneous property, if there is minimum changes, or there is no changes, on the load, firmware, software, or any other conditions. Alternatively, multiple values of a same local instantaneous property can be calculated for different periods of time, such as multiple consecutive periods of time, which can provide indications of whether or not the property is changed with respect to time. The change of the local instantaneous property can be attributed to a change in load conditions, firmware, software, operating conditions such as temperature changes, or user conditions such as different habits of loading or unloading files.

Thus, if there are changes, such as a change in a load, a firmware or a software, the local instantaneous property can be changed accordingly. For example, a local instantaneous property calculated after a change in a load, a firmware or a software can provide an indication of the effects of the new load, the new firmware or the new software. By comparing the new local instantaneous property with the previous local instantaneous property, an assessment can be formed as to the performance of the new load, the new firmware or the new software, compared to the previous load, the previous firmware or the previous software. The assessment can assist in helping improving the solid state drive, such as knowing the effect of the changes, reverting to the old conditions, or making improvements to the new load. firmware or software if the new local instantaneous property is worse.

In some embodiments, the instantaneous property, which is discussed above, can be based on a present instant or period, together with optional past periods. For example, an instantaneous rate of the consumption of the erase counts can be can be based only on the present instant or on a period of time. Thus the instantaneous rate of erase count consumption can be considered as a local instantaneous property. In contrast, an instantaneous remaining lifetime can be based on the instantaneous rate of erase count consumption, together with consumption of erase counts from the beginning of the solid state drive until the present. Thus the instantaneous remaining lifetime can be different than a local instantaneous property.

In some embodiments, the local instantaneous property can be similar to the instantaneous property that is based only on an instant or on a period of time, without relying on the past history.

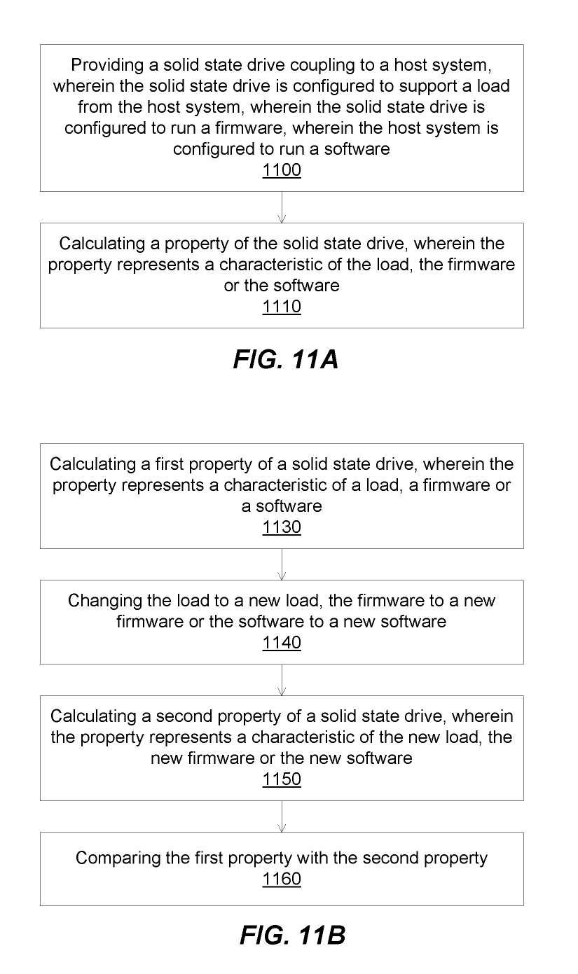

FIGS. 11A-11B illustrate flow charts for calculating effect of software, firmware or load on a solid state drive according to some embodiments. The solid state drive can be configured to support a load from a host system. For example, the solid state drive can be connected to the host system, and functioned as a load, e.g., a storage device, for the host system. The host system can be configured to run a software, for example, to access the solid state drive. The solid state drive can be configured to run a firmware, for example, to map the addresses provided by the host system through the software to flash memory addresses of the solid state drive. The firmware can include monitor program, such as SMART, which can calculate and store indicators of the solid state drive.

In some embodiments, local instantaneous properties can be calculated for a present period. The local instantaneous properties can provide indications or performance of the present load, firmware or software, together with possible ambient and user conditions. By comparing the present local instantaneous properties with past local instantaneous properties, changes and degrees of changes to the solid state drive can be observed.

In some embodiments, local instantaneous properties can be calculated continuously, e.g., for consecutive periods. The series of local instantaneous properties, e.g., the local instantaneous properties calculated as a function of time or index, can provide indications or performance of the solid state drive during the time in which local instantaneous properties are calculated. From the series of local instantaneous properties, changes and degrees of changes to the solid state drive can be observed, such as changes to a load, firmware or software, together with possible changes in ambient and user conditions.

FIG. 11A shows a process for obtaining a property of a solid state drive, with the property represents a characteristic of the solid state drive at an instant, or in a period. The property can be local instantaneous property as discussed above.

Operation 1100 provides a solid state drive coupling to a host system, wherein the solid state drive is configured to support a load from the host system, wherein the solid state drive is configured to run a firmware, wherein the host system is configured to run a software. Operation 1110 calculates a property of the solid state drive, wherein the property represents a characteristic of the load, the firmware or the software.

In some embodiments, the calculated property can include life acceleration data, such as a number of memories that can be written to the solid state drive, or a remaining lifetime of the solid state drive. The calculated property can include life acceleration data at the operating conditions in the instant or period that the property are calculated. The calculated property can provide a feed back to a user on the way the user uses the solid state drive. For example, the calculated property can include a remaining lifetime, and by monitoring the remaining lifetime property, a user can optimize or improve the usage of the solid state drive.

In some embodiments, the calculated property can be compared with a value, such as a standard value, e.g., a rated value for the property. For example, if the calculated property is the lifetime of the solid state drive, a rated value for a lifetime of a solid state can be about 5 years. The calculated lifetime can be compared with the standard value, for example, to give a user a sense of the operation of the solid state drive as compared with standard operations.

In some embodiments, a notification can be provided to the user. For example, if the lifetime is much less than the standard value of 5 years, an alert can be sent to the user.

FIG. 11B shows a process for assessing a new load, a new firmware or a new software on a solid state drive. By comparing local instantaneous properties calculated in different periods, the effect of a load, firmware or software can be evaluated. For example, after changing a load, e.g., a host system can assess the solid state drive as a storage for a different program, life acceleration parameters, such as remaining lifetime, can be calculated for a period of time with the new load. After updating a firmware on a solid state drive, life acceleration parameters, such as remaining lifetime, can be calculated for a period of time with the new firmware. After updating or changing a software on a host, e.g., the software that accesses the solid state drive as a storage medium, life acceleration parameters, such as remaining lifetime, can be calculated for a period of time with the new software. The life acceleration parameters can be calculated as to represent a characteristic of the new load, the new firmware or the new software. By comparing the life acceleration parameters on the new load, the new firmware or the new software with the life acceleration parameters calculated previously for the old load, the old firmware or the old software, an effect can be evaluated.

Operation 1130 calculates a first property of a solid state drive, wherein the property represents a characteristic of a load, a firmware or a software. The first property can be a lifetime of the solid state drive or an remaining amount of memory that can be written to the solid state drive.

Operation 1140 changes the load to a new load, the firmware to a new firmware or the software to a new software. Operation 1150 calculates a second property of a solid state drive, wherein the property represents a characteristic of the new load, the new firmware or the new software. Operation 1160 compares the first property with the second property.

In some embodiments, a notification can be provided to a user. For example, if the comparison shows a significant degradation, an alert can be sent to the user.

In some embodiments, the property can be calculated from a logged data set, e.g., multiple logged data collected at different times. The logged data can include attributes of the solid state drive, such as accumulated erase counts, error rates, temperature, or lifetime.

In some embodiments, the present invention discloses methods and systems for regression testing of software or firmware for solid state drives. Programs, including firmware and software, after being developed or changed, can undergo tests, including regression testing to uncover new software bugs, or regressions, in existing functional and non-functional areas of a system. For example, a firmware can be updated or upgraded, and a regression testing can be performed before releasing.

In some embodiments, the present invention discloses methods and systems for integrating a local instantaneous property calculation in a regression test. A local instantaneous property calculation can provide information about the solid state drive at a current time, thus can generate information specifically to the new firmware or software, without being contaminated with the old firmware or software. Thus the current calculated local instantaneous property can be compared with a standard value or with a previously calculated local instantaneous property, e.g., a local instantaneous property calculated in a period of time in which the old firmware or software is running. Any degradation performance can be attributed to the new firmware or software, which can indicate poor performance. For example, a lifetime calculation can be performed for a new firmware. If the lifetime is significantly less, for example, as compared to a standard 5 year lifetime, then the performance of the new firmware might need to be improved.

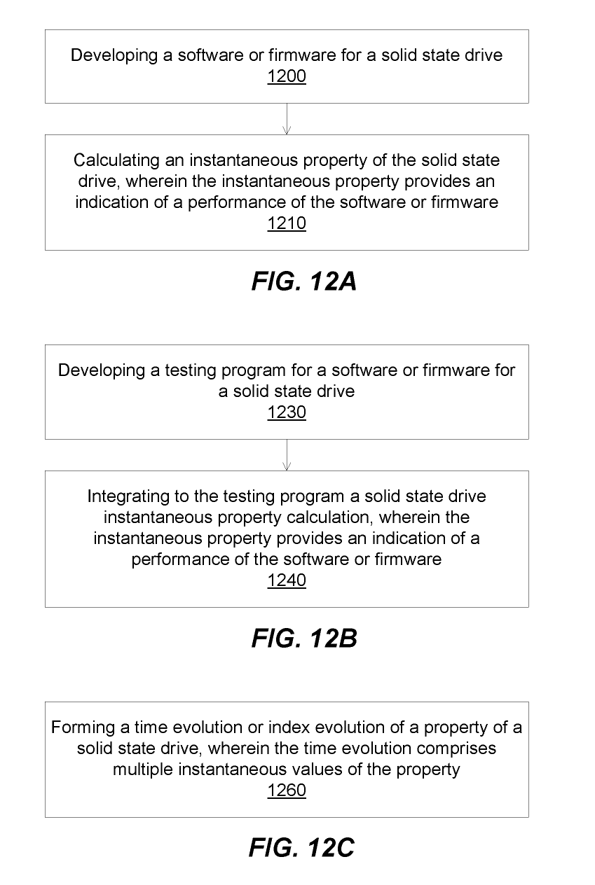

FIGS. 12A-12C illustrate flow charts for using a property calculation in a regression test according to some embodiments. In FIG. 12A, operation 1200 develops a software or firmware for a solid state drive. Operation 1210 calculates a local instantaneous property of the solid state drive, wherein the local instantaneous property provides an indication of a performance of the software or firmware, without being influenced by the previous software or firmware.

FIG. 12B shows a process for forming a test program for testing a firmware or a software. A local instantaneous property calculation algorithm can be incorporated in a test program for regression testing, e.g., to see if the newly developed firmware or software can performed as good as a standard program, or can performed as good as a previous version. The performance degradation, indicated by the local instantaneous property, can indicate the presence of software bugs.

Operation 1230 develops a testing program for a software or firmware for a solid state drive. Operation 1240 integrates to the testing program a solid state drive a local instantaneous property calculation, wherein the local instantaneous property provides an indication of a performance of the software or firmware in a period of time or index.

In some embodiments, the present invention discloses methods and systems for forming time-evolution or index evolution properties for a solid state drive (operation 1260) (FIG. 12C). A series of local instantaneous properties can be assembled to form a time evolution or index evolution of the properties. In the evolution property curves, the property at any point can be a local instantaneous property, e.g., the property within that period and not influenced by past property values.

The evolution property curves can include adjusted property values, e.g., property values corrected to be at same conditions. Properties of the solid state drive can be calculated from the evolution property curves.

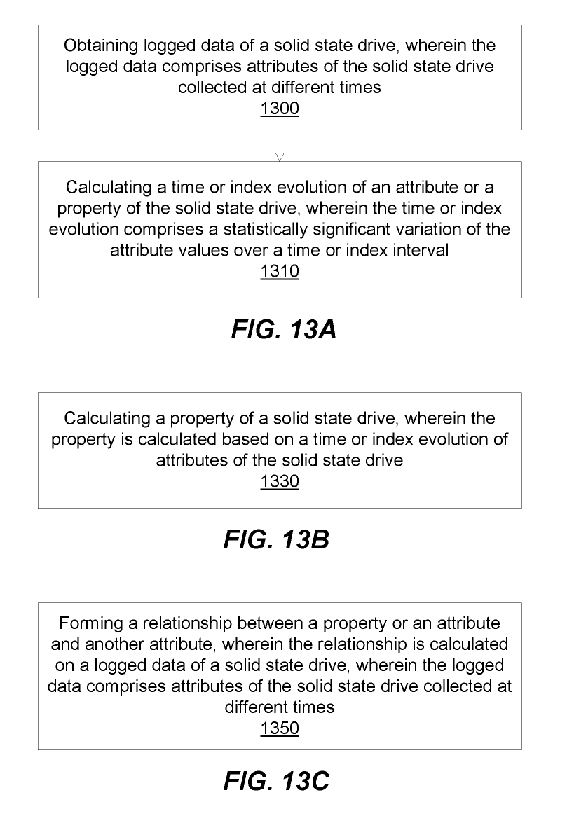

FIG. 13A-13C illustrate time or index evolution property calculations according to some embodiments. In FIG. 13A, operation 1300 obtains logged data of a solid state drive, wherein the logged data comprises attributes of the solid state drive collected at different times.

Operation 1310 calculates a time or index evolution of an attribute or a property of the solid state drive, wherein the time or index evolution comprises changes of the attribute values over a time or index interval. The calculation can use adjusted values of the attributes or properties.

The time or index evolution can be used to calculate properties of a solid state drive. In FIG. 13B, operation 1330 calculates a property of a solid state drive, wherein the property is calculated based on a time or index evolution of attributes of the solid state drive. For example, from a time evolution curve of erase count consumption, a remaining lifetime can be calculated by integrating the curve, to find the time that the number of erase count reaches a maximum number of erase counts.

The time or index evolution can be used to calculate relationships between properties of a solid state drive. In FIG. 13C, operation 1350 forms a relationship between different properties of the solid state drive, wherein the relationship is calculated on a logged data set of a solid state drive, wherein the logged data set comprises attributes of the solid state drive collected at different times.

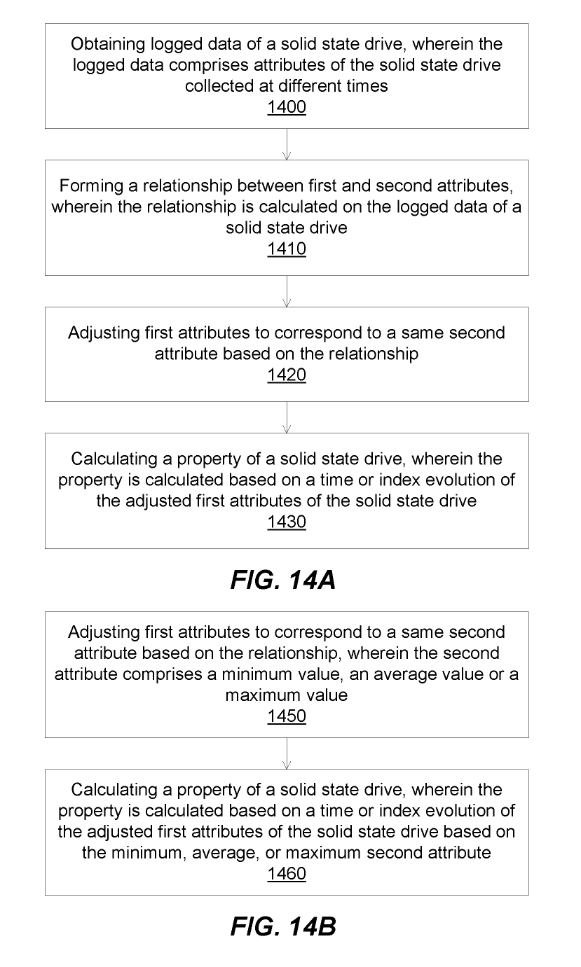

FIGS. 14A-14B illustrate flow charts for calculating adjusted time evolution properties according to some embodiments. In FIG. 14A, operation 1400 obtains logged data of a solid state drive, wherein the logged data comprises attributes of the solid state drive collected at different times. Operation 1410 forms a relationship between first and second attributes, wherein the relationship is calculated on the logged data of a solid state drive. Operation 1420 adjusts first attributes in the logged data to correspond to a same second attribute based on the relationship. Operation 1430 calculates a property of a solid state drive, wherein the property is calculated based on a time or index evolution of the adjusted first attributes of the solid state drive

In FIG. 14B, operation 1450 adjusts first attributes in the logged data to correspond to a same second attribute based on the relationship, wherein the second attribute comprises a minimum value, an average value or a maximum value. Operation 1460 calculates a property of a solid state drive, wherein the property is calculated based on a time or index evolution of the adjusted first attributes of the solid state drive based on the minimum, average, or maximum second attribute.

In some embodiments, provided is a machine readable storage, having stored there on a computer program having a plurality of code sections for causing a machine to perform the various steps and/or implement the components and/or structures disclosed herein. In some embodiments, the present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, a nonvolatile electronic memory, or the like. The software program may be run on a variety of devices, e.g. a processor.

In some embodiments, the methods can be realized in hardware, software, or a combination of hardware and software. The methods can be realized in a centralized fashion in a data processing system, such as a computer system or in a distributed fashion where different elements are spread across several interconnected computer systems. Any kind of computer system or other apparatus adapted for carrying out the methods described herein can be used. A typical combination of hardware and software can be a general-purpose computer system with a computer program that can control the computer system so that the computer system can perform the methods. The methods also can be embedded in a computer program product, which includes the features allowing the implementation of the methods, and which when loaded in a computer system, can perform the methods.

The terms “computer program”, “software”, “application”, variants and/or combinations thereof, in the context of the present specification, mean any expression, in any language, code or notation, of a set of instructions intended to cause a system having an information processing capability to perform a particular function either directly. The functions can include a conversion to another language, code or notation, or a reproduction in a different material form. For example, a computer program can include a subroutine, a function, a procedure, an object method, an object implementation, an executable application, an applet, a servlet, a source code, an object code, a shared library/dynamic load library and/or other sequence of instructions designed for execution on a data processing system, such as a computer.

In some embodiments, the methods can be implemented using a data processing system, such as a general purpose computer system. A general purpose computer system can include a graphical display monitor with a graphics screen for the display of graphical and textual information, a keyboard for textual entry of information, a mouse for the entry of graphical data, and a computer processor. In some embodiments, the computer processor can contain program code to implement the methods. Other devices, such as a light pen (not shown), can be substituted for the mouse. This general purpose computer may be one of the many types well known in the art, such as a mainframe computer, a minicomputer, a workstation, or a personal computer.

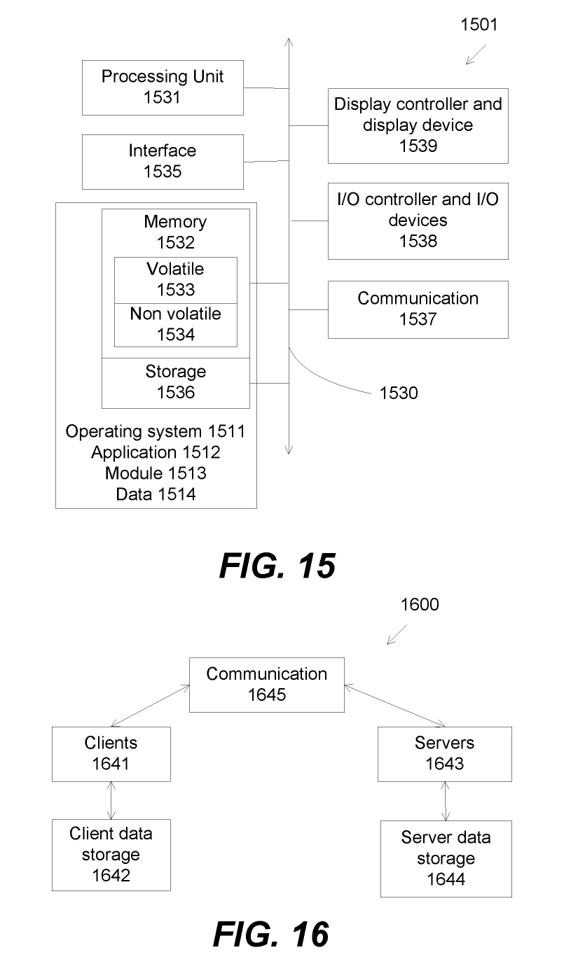

FIG. 15 illustrates a computing environment according to some embodiments. An exemplary environment for implementing various aspects of the invention includes a computer 1501, comprising a processing unit 1531, a system memory 1532, and a system bus 1530. The processing unit 1531 can be any of various available processors, such as single microprocessor, dual microprocessors or other multi-processes or architectures. The system bus 1530 can be any type of bus structures or architectures, such as 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), or Small Computer Systems Interface (SCSI).

The system memory 1532 can include volatile memory 1533 and nonvolatile memory 1534. Nonvolatile memory 1534 can include read only memory (ROM), programmable ROM (PROM), electrically programmable ROM (EPROM), electrically erasable ROM (EEPROM), or flash memory. Volatile memory 1533, can include random access memory (RAM), synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), or direct Rambus RAM (DRRAM).

Computer 1501 also includes storage media 1536, such as removable/nonremovable, volatile/nonvolatile disk storage, magnetic disk drive, floppy disk drive, tape drive, Jaz drive, Zip drive, LS-100 drive, flash memory card, memory stick, optical disk drive such as a compact disk ROM device (CD-ROM), CD recordable drive (CD-R Drive), CD rewritable drive (CD-RW Drive) or a digital versatile disk ROM drive (DVD-ROM). A removable or non-removable interface 1535 can be used to facilitate connection. These storage devices can be considered as part of the I/O device 1538 or at least they can be connected via the bus 1530. Storage devices that are “on board” generally include EEPROM used to store the BIOS.

The computer system 1501 further can include software to operate in the environment, such as an operating system 1511, system applications 1512, program modules 1513 and program data 1514, which are stored either in system memory 1532 or on disk storage 1536. Various operating systems or combinations of operating systems can be used.

Input devices can be used to enter commands or data, and can include a pointing device such as a mouse, trackball, stylus, touch pad, keyboard, microphone, joystick, game pad, satellite dish, scanner, TV tuner card, sound card, digital camera, digital video camera, web camera, and the like, connected through interface ports 1538. Interface ports 1538 can include a serial port, a parallel port, a game port, a universal serial bus (USB), and a 1394 bus. The interface ports 1538 can also accommodate output devices 1521. For example, a USB port may be used to provide input to computer 1501 and to output information from computer 1501 to an output device 1521. Output adapter 1539, such as video or sound cards, is provided to connect to some output devices such as monitors, speakers, and printers.

Computer 1501 can operate in a networked environment with remote computers. The remote computers, including a memory storage device, can be a personal computer, a server, a router, a network PC, a workstation, a microprocessor based appliance, a peer device or other common network node and the like, and typically includes many or all of the elements described relative to computer 1501. Remote computers can be connected to computer 1501 through a network interface 1535 and communication connection 1537, with wire or wireless connections. Network interface 1535 can be communication networks such as local-area networks (LAN), wide area networks (WAN) or wireless connection networks. LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

FIG. 16 is a schematic block diagram of a sample computing environment with which the present invention can interact. The system 1600 includes a plurality of client systems 1641. The system 1640 also includes a plurality of servers 1643. The servers 1643 can be used to employ the present invention. The system 1640 includes a communication network 1645 to facilitate communications between the clients 1641 and the servers 1643. Client data storage 1642, connected to client system 1641, can store information locally. Similarly, the server 1643 can include server data storages 1644.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method comprising
periodically recording attributes of a solid state drive, wherein the attributes are generated by a program for monitoring the solid state drive;
recording the time of the attribute recording.

2. A method as in claim 1
wherein the attributes are recorded at a regular time or index interval.

3. A method as in claim 1
wherein the regular index interval comprises a time interval in which there is a regular amount of memory is written to the solid state drive.

4. A method as in claim 1
wherein the program comprises a Self-Monitoring, Analysis and Reporting Technology (SMART) system.

5. A method as in claim 1
wherein the attributes comprise at least one of
an accumulated value of wear leveling of the memory of the solid state drive,
a number or percentage of memory erased or a difference between most worn and least worn memories,
a percentage of remaining erase cycles or a percentage of ease cycles performed,
an inside temperature of the solid state drive,
an accumulated error rate of the solid state drive,
a number of remaining reserved block count or a number of retired block count,
an accumulated number of memory read or memory written,
an accumulated number of power on hours, and
a value of remaining life in term of percentage of erase cycles or in term of reserved memory block.

6. A method comprising
obtaining logged data of a solid state drive, wherein the logged data comprise attributes of the solid state drive recorded at different times;
calculating a property of a solid state drive using the logged data, wherein the property comprises a unit of time.

7. A method as in claim 6
wherein the property comprises an instantaneous property.

8. A method as in claim 6
wherein the property comprises a property representative of an instant or of an period of time.

9. A method as in claim 6
wherein the property is calculated based on a time evolution of the attributes of the solid state drive.

10. A method as in claim 6
wherein the property is calculated in a time interval long enough to be statistically significant, wherein the time interval is short enough with respect to the life of the solid state drive.

11. A method as in claim 6
wherein the time interval comprises a time interval in which a consumption of program/erase cycles is less than 1% of a maximum number of program/erase cycles, and in which a consumption of program/erase cycles is more than 0.1% of a maximum number of program/erase cycles.

12. A method as in claim 6
wherein the property comprises a lifetime expectancy of the solid state drive expressed in a unit of time.

13. A method as in claim 6
wherein the property is calculated based on a curve fitting of the attributes of the solid state drive.

14. A method as in claim 6
wherein the property is calculated using adjusted values, wherein the adjusted values are adjusted to be at a same temperature.

15. A method as in claim 6
wherein the attributes comprise temperature,
wherein the method further comprises
forming a relationship between a first attribute of the attributes and temperature using the logged data;
adjusting the values of the first attributes to be at a same temperature using the relationship,
wherein the property is calculated using adjusted values.

16. A method comprising
providing a solid state drive coupled to a host system;
replacing a load with a new load, a firmware with a new firmware, or a software with a new software, wherein the solid state drive is configured to support the load or the new load from the host system, wherein the solid state drive is configured to run the firmware or the new firmware, wherein the host system is configured to run the software or the new software for accessing the solid state drive;
obtaining logged data of a solid state drive, wherein the logged data comprise attributes of the solid state drive recorded at different times;
calculating a first property of a solid state drive using the logged data, wherein the property represents a characteristic of the new load, the new firmware or the new software.

17. A method as in claim 16
wherein the first property comprises a remaining lifetime of the solid state drive in unit of time or a remaining amount of memory that can be written to the solid state drive.

18. A method as in claim 16 further comprising
calculating a second property of a solid state drive using the logged data, wherein the property represents a characteristic of the load, the firmware or the software;
comparing the first property with the second property.

19. A method as in claim 16 further comprising
comparing the first property with a standard value;
notifying a user if the first property is different from the standard value.

20. A method as in claim 16
wherein the property is calculated in a time or index interval under which the new load, new software or new firmware is used.
